(19) United States
(12) Patent Application Publication
(10) Pub. No.: US 2026/0253216 A1
(43) Pub. Date: Aug. 27, 2026

(54) INFRARED IMAGING SYSTEM, AND DETECTION METHOD AND APPARATUS BASED ON INFRARED IMAGING SYSTEM

(71) Applicant: NANJING UNIVERSITY, Nanjing (CN)

(72) Inventors: Wei WANG, Nanjing (CN); Aosheng CHANG, Nanjing (CN); Haoran HAN, Nanjing (CN)

(21) Appl. No.: 19/405,962

(22) Filed: Dec. 2, 2025

(30) Foreign Application Priority Data
Feb. 25, 2025 (CN) 202510213294.4

(51) Int. Cl. G06T 7/00; G01J 5/00; H04N 23/20

(52) U.S. Cl. CPC G06T 7/0012; G01J 5/0003; H04N 23/20; G01J 2005/0077; G06T 2207/10016; G06T 2207/10048; G06T 2207/30024

(57) ABSTRACT

An infrared imaging system, and a detection method and apparatus based thereon are provided. The infrared imaging system includes an in-situ reaction cell module, an infrared optical imaging module, and a data processing module. The infrared optical imaging module is configured for acquiring infrared images, while the data processing module is configured to extract kinetic curves therefrom. In gas-solid reaction studies, the kinetic curve is fitted via a predetermined adsorption kinetic equation to determine kinetic and thermodynamic data. For a gas-liquid reaction, the kinetic curve is fitted via a thermal dissipation kinetic equation to ascertain the thermodynamic data.

### CROSS-REFERENCE TO RELATED PRESENT APPLICATION

This patent application claims the benefit and priority of Chinese Patent Application No. 202510213294.4 filed with the China National Intellectual Property Administration on Feb. 25, 2025, the disclosure of which is incorporated by reference herein in its entirety as part of the application.

### TECHNICAL FIELD

The present disclosure relates to the technical field of heterogeneous interface reaction research, and in particular to an infrared imaging system, and a detection method and apparatus based on an infrared imaging system.

### BACKGROUND

This section is intended to provide background or context to the embodiment of the present disclosure set forth herein. The description here is not admitted to be the prior art just because of being included in this section.

For gas-solid interface reaction, a metal oxide is one of the most important solid materials, which has an important application in heterogeneous catalysis, photocatalysis and electronic and chemical sensing fields. The metal oxide is not only a catalytic active center, but also serves as a supporting structure to promote the reaction. An oxygen vacancy structure on the surface of the metal oxide is crucial for heterogeneous catalysis. An oxygen vacancy is formed by the lack of lattice oxygen under high temperature or reduction conditions. Since the oxygen vacancy was proposed, it has been confirmed by the technologies such as a Scanning Tunneling Microscope (STM) and an Atomic Force Microscope (AFM) that the oxygen vacancy is an active site of surface reaction, which affects the electronic and chemical properties of the material surface, and then regulates the kinetics and mechanisms of chemical reaction. The oxygen vacancy on the surface of a transition metal oxide is highly active, and it is easy to adsorb and activate oxygen molecules to form active oxygen species. The concentration change of these species affects the chemical and electronic properties of the material surface. Although the technologies such as Electron Paramagnetic Resonance (EPR), Nuclear Magnetic Resonance (NMR) Spectroscopy, and X-ray Photoelectron Spectroscopy (XPS) may quantitatively characterize surface active oxygen species, it is difficult to monitor the dynamic changes of the surface active oxygen species in real time. Moreover, these technologies all lack sufficient measuring throughput to achieve efficient kinetic detection.

The capture of carbon dioxide (CO₂) in gas-solid interface reaction is of great significance in reducing greenhouse gas emissions. At present, alkaline absorbents of organic amine are widely used because of the considerable absorption performance, the mature industrial technology and the low material cost. However, high renewable energy consumption greatly limits the further application of the alkaline absorbents in carbon dioxide. A high-throughput-based screening strategy is expected to screen out a high-performance CO₂ absorbent from a large number of potential excellent absorbent formulations. Therefore, it is particularly urgent to develop a high-throughput-based screening strategy.

### SUMMARY

The embodiment of the present disclosure provides an infrared imaging system, which is used to efficiently quantify interaction between heterogeneous interfaces with a high throughput, achieve reaction kinetic measurement between a metal oxide surface and a gas molecule, and screen out a high-performance CO₂ absorbent from a large number of potential excellent absorbent formulations. The infrared imaging system includes an in-situ reaction cell module, an infrared optical imaging module, and a data processing module; where
the in-situ reaction cell module includes an in-situ gas flow cell, a mass flowmeter and a gas source; the in-situ gas flow cell includes a gas flow cavity, a heating stage, and a metal oxide library substrate arranged in the gas flow cavity and placed on the heating stage; the metal oxide library substrate is provided with a plurality of holes into which reaction samples are placed; the reaction sample includes a solid sample or a gas sample; the gas source is configured to deliver reaction gas into the gas flow cavity of the in-situ gas flow cell through the mass flowmeter; the mass flowmeter is configured to control a concentration and a flow rate of the reaction gas; and the heating stage is configured to heat the reaction sample;
the infrared optical imaging module is configured to acquire infrared images of a surface of the reaction sample and send the infrared images to the data processing module;
the data processing module is configured to perform data analysis on the infrared images received and extract a kinetic curve from the infrared images;
in a case that the reaction sample is the solid sample, the data processing module is further configured to fit the kinetic curve by using a predetermined adsorption kinetic equation to determine kinetic data of the surface of the reaction sample, and/or fit the kinetic curve by using a thermal dissipation kinetic equation to determine thermodynamic data of the surface of the reaction sample; wherein the kinetic curve is an infrared image intensity curve; and
in a case that the reaction sample is a liquid sample, the data processing module is further configured to fit the kinetic curve by using a thermal dissipation kinetic equation to determine the thermodynamic data of the surface of the reaction sample.

The embodiment of the present disclosure further provides a detection method based on an infrared imaging system, which is used to efficiently quantify interaction between heterogeneous interfaces with a high throughput, achieve reaction kinetic measurement between a metal oxide surface and a gas molecule, and screen out a high-performance CO₂ absorbent from a large number of potential excellent absorbent formulations. The method is applied to the infrared imaging system described above, including:
acquiring the infrared images of the surface of the reaction sample; where the reaction sample includes the solid sample or the gas sample;
performing the data analysis on the infrared images and extracting the kinetic curve from the infrared images;
in the case that the reaction sample is the solid sample, fitting the kinetic curve by using the predetermined adsorption kinetic equation to determine the kinetic data of the surface of the reaction sample, and/or fitting the kinetic curve by using the thermal dissipation kinetic equation to determine the thermodynamic data of the surface of the reaction sample; where the kinetic curve is the infrared image intensity curve; and
in the case that the reaction sample is the liquid sample, fitting the kinetic curve by using the thermal dissipation kinetic equation to determine the thermodynamic data of the surface of the reaction sample.

The embodiment of the present disclosure further provides a detection apparatus based on an infrared imaging system, which is used to efficiently quantify interaction between heterogeneous interfaces with a high throughput, achieve reaction kinetic measurement between a metal oxide surface and a gas molecule, and screen out a high-performance CO₂ absorbent from a large number of potential excellent absorbent formulations. The apparatus includes the infrared imaging system described above, and further includes:
an acquisition module, configured to acquire the infrared images of the surface of the reaction sample; where the reaction sample includes the solid sample or the gas sample;
a data analysis module, configured to perform the data analysis on the infrared images and extract the kinetic curve from the infrared images;
a kinetic data determination module, configured to, in the case that the reaction sample is the solid sample, fit the kinetic curve by using the predetermined adsorption kinetic equation to determine the kinetic data of the surface of the reaction sample, and/or fit the kinetic curve by using the thermal dissipation kinetic equation to determine the thermodynamic data of the surface of the reaction sample; where the kinetic curve is the infrared image intensity curve; and
a thermodynamic data determination module, configured to, in the case that the reaction sample is the liquid sample, fit the kinetic curve by using the thermal dissipation kinetic equation to determine the thermodynamic data of the surface of the reaction sample.

The embodiment of the present disclosure further provides a computer device, including a memory, a processor and a computer program stored in the memory and executable on the processor, where the processor, when executing the computer program, implements the detection method based on the infrared imaging system described above.

The embodiment of the present disclosure further provides a computer-readable storage medium, having a computer program stored thereon, where the computer program, when executed by a processor, implements the detection method based on the infrared imaging system described above.

The embodiment of the present disclosure further provides a computer program product, including a computer program, where the computer program, when executed by a processor, implements the detection method based on the infrared imaging system described above.

Compared with the technical solution of the oxygen vacancy feature detection of the metal oxide surface in the conventional art, according to the embodiment of the present disclosure, an infrared imaging system includes: an in-situ reaction cell module, an infrared optical imaging module, and a data processing module; where the in-situ reaction cell module includes an in-situ gas flow cell, a mass flowmeter and a gas source; the in-situ gas flow cell includes a gas flow cavity, a heating stage, and a metal oxide library substrate arranged in the gas flow cavity and placed on the heating stage; the metal oxide library substrate is provided with a plurality of holes into which reaction samples are placed; the reaction sample includes a solid sample or a gas sample; the gas source is configured to deliver reaction gas into the gas flow cavity of the in-situ gas flow cell through the mass flowmeter; the mass flowmeter is configured to control a concentration and a flow rate of the reaction gas; the heating stage is configured to heat the reaction sample; the infrared optical imaging module is configured to acquire infrared images of a surface of the reaction sample and send the infrared images to the data processing module; the data processing module is configured to perform data analysis on the infrared images received and extract a kinetic curve from the infrared images; when the reaction sample is a solid sample, the data processing module is further configured to fit the kinetic curve by using a predetermined adsorption kinetic equation to determine kinetic data of the surface of the reaction sample, and/or fit the kinetic curve by using a thermal dissipation kinetic equation to determine thermodynamic data of the surface of the reaction sample; where the kinetic curve is an infrared image intensity curve; and when the reaction sample is a liquid sample, the data processing module is further configured to fit the kinetic curve by using the thermal dissipation kinetic equation to determine the thermodynamic data of the surface of the reaction sample, which may efficiently quantify interaction between heterogeneous interfaces with a high throughput, achieve reaction kinetic measurement between a metal oxide surface and a gas molecule, and screen out a high-performance CO₂ absorbent from a large number of potential excellent absorbent formulations.

### BRIEF DESCRIPTION OF THE DRAWINGS

In order to more clearly explain the technical solution in the embodiments of the present disclosure or the prior art, the drawings needed to be used in the description of the embodiments or the prior art will be briefly introduced below. Obviously, the drawings in the following description are only some embodiments of the present disclosure. Other drawings may be obtained according to these drawings without paying creative labor for those skilled in the art. In the drawings:

FIG. 1 is a schematic diagram of an infrared imaging system according to an embodiment of the present disclosure.

FIG. 2 is a schematic diagram of a specific example of the infrared imaging system according to the embodiment of the present disclosure.

FIG. 3 is a schematic diagram of another specific example of the infrared imaging system according to the embodiment of the present disclosure.

FIG. 4 is a schematic diagram of an infrared optical imaging module according to an embodiment of the present disclosure.

FIG. 5A is a bright-field image of a metal oxide library substrate in which a plurality of reaction samples are placed according to an embodiment of the present disclosure.

FIG. 5B is an infrared image of a metal oxide library substrate in which a plurality of reaction samples are placed according to an embodiment of the present disclosure.

FIG. 6 is a flowchart of a detection method based on the infrared imaging system according to an embodiment of the present disclosure.

FIG. 7A is a reaction kinetic curve in a plurality of cycles of adsorption and desorption of carbon monoxide molecules on and from surfaces of zinc oxide powder according to an embodiment of the present disclosure.

FIG. 7B is an enlarged view of a part of the reaction kinetic curve in the plurality of cycles of adsorption and desorption of carbon monoxide molecules on and from surfaces of zinc oxide powder according to an embodiment of the present disclosure.

FIG. 8A is a diagram of kinetic curves of a surface of zinc oxide powder according to an embodiment of the present disclosure.

FIG. 8B is a diagram of correlation between an apparent response kinetic constant of a surface of zinc oxide powder and a partial pressure of carbon monoxide gas according to an embodiment of the present disclosure.

FIG. 8C is a diagram of kinetic curves of a surface of tungsten trioxide powder according to an embodiment of the present disclosure.

FIG. 8D is a diagram of correlation between an apparent response kinetic constant of a surface of tungsten trioxide powder and a partial pressure of carbon monoxide gas according to an embodiment of the present disclosure.

FIG. 9A shows infrared intensity change images of surfaces of a plurality of metal oxide samples according to an embodiment of the present disclosure.

FIGS. 9B-9M are schematic diagrams of kinetic curves and fitting curves of metal oxide samples in a metal oxide library substrate according to an embodiment of the present disclosure; in which FIG. 9B is a schematic diagram of a kinetic curve and a fitting curve of metal oxide sample of ZnO in a metal oxide library substrate, FIG. 9C is a schematic diagram of a kinetic curve and a fitting curve of metal oxide sample of TiO₂ (Rutile) in a metal oxide library substrate, FIG. 9D is a schematic diagram of a kinetic curve and a fitting curve of metal oxide sample of TiO₂ (Anatase) in a metal oxide library substrate, FIG. 9E is a schematic diagram of a kinetic curve and a fitting curve of metal oxide sample of SnO₂ in a metal oxide library substrate, FIG. 9F is a schematic diagram of a kinetic curve and a fitting curve of metal oxide sample of WO₃ in a metal oxide library substrate, FIG. 9G is a schematic diagram of a kinetic curve and a fitting curve of metal oxide sample of MoO₃ in a metal oxide library substrate, FIG. 9H is a schematic diagram of a kinetic curve and a fitting curve of metal oxide sample of CeO₂ in a metal oxide library substrate, FIG. 9I is a schematic diagram of a kinetic curve and a fitting curve of metal oxide sample of Cr₂O₃ in a metal oxide library substrate, FIG. 9J is a schematic diagram of a kinetic curve and a fitting curve of metal oxide sample of V₂O₅ in a metal oxide library substrate, FIG. 9K is a schematic diagram of a kinetic curve and a fitting curve of metal oxide sample of In₂O₃ in a metal oxide library substrate, FIG. 9L is a schematic diagram of a kinetic curve and a fitting curve of metal oxide sample of α-Fe₂O₃ in a metal oxide library substrate, and FIG. 9M is a schematic diagram of a kinetic curve and a fitting curve of metal oxide sample of Fe₃O₄ in a metal oxide library substrate.

FIG. 10 is a diagram of a near-infrared spectrum and a spectrum fitting curve of carbon monoxide before and after adsorption on a surface of zinc oxide according to an embodiment of the present disclosure.

FIG. 11A shows an evolution spectrum of a near-infrared spectrum in a cycle of adsorption and desorption of carbon monoxide on and from a surface of zinc oxide according to an embodiment of the present disclosure.

FIG. 11B is a diagram of an evolution kinetic curve of a surface infrared emissivity de according to an embodiment of the present disclosure.

FIG. 12 is a diagram of a kinetic curve of a surface temperature change in a cycle of adsorption and desorption of carbon monoxide on and from a surface of zinc oxide according to an embodiment of the present disclosure.

FIG. 13 is a diagram of the correlation between a surface emissivity and a surface radiation infrared signal intensity in a cycle of absorption and desorption of carbon monoxide on and from a surface of zinc oxide according to an embodiment of the present disclosure.

FIG. 14A is a bright-field image of organic amine alkaline solution sample libraries with different concentration ratios according to an embodiment of the present disclosure.

FIG. 14B is an infrared image of organic amine alkaline solution sample libraries with different concentration ratios according to an embodiment of the present disclosure.

FIGS. 14C-14H are diagrams of kinetic curves characterizing a temperature change of carbon dioxide molecules and organic amine alkaline solutions with different concentrations in an adsorption process according to an embodiment of the present disclosure; in which FIG. 14C is a diagram of a kinetic curve characterizing a temperature change of carbon dioxide molecules and organic amine alkaline solution of #1, FIG. 14D is a diagram of a kinetic curve characterizing a temperature change of carbon dioxide molecules and organic amine alkaline solution of #2,FIG. 14E is a diagram of a kinetic curve characterizing a temperature change of carbon dioxide molecules and organic amine alkaline solution of #3, FIG. 14F is a diagram of a kinetic curve characterizing a temperature change of carbon dioxide molecules and organic amine alkaline solution of #4, FIG. 14G is a diagram of a kinetic curve characterizing a temperature change of carbon dioxide molecules and organic amine alkaline solution of #5, and FIG. 14H is a diagram of a kinetic curve characterizing a temperature change of carbon dioxide molecules and organic amine alkaline solution of #6.

FIGS. 14I-14N are diagrams of temperature rise processes of an ideal adiabatic system of carbon dioxide molecules and organic amine alkaline solutions with different concentrations in a reaction process after kinetic fitting according to an embodiment of the present disclosure; in which FIG. 14I is a diagram of a temperature rise process of an ideal adiabatic system of carbon dioxide molecules and organic amine alkaline solutions of #1, FIG. 14J is a diagram of a temperature rise process of an ideal adiabatic system of carbon dioxide molecules and organic amine alkaline solutions of #2, FIG. 14K is a diagram of a temperature rise process of an ideal adiabatic system of carbon dioxide molecules and organic amine alkaline solutions of #3, FIG. 14L is a diagram of a temperature rise process of an ideal adiabatic system of carbon dioxide molecules and organic amine alkaline solutions of #4, FIG. 14M is a diagram of a temperature rise process of an ideal adiabatic system of carbon dioxide molecules and organic amine alkaline solutions of #5, and FIG. 14N is a diagram of a temperature rise process of an ideal adiabatic system of carbon dioxide molecules and organic amine alkaline solutions of #6.

FIG. 15 is a structural block diagram of a detection apparatus based on an infrared imaging system according to an embodiment of the present disclosure.

FIG. 16 is a schematic structural diagram of a computer device according to an embodiment of the present disclosure.

### DETAILED DESCRIPTION OF THE EMBODIMENTS

In order to make the objective, the technical solution and the advantages of the embodiment of the present disclosure more clear, the embodiment of the present disclosure will be further described in detail with reference to the drawings. Here, the exemplary embodiments of the present disclosure and the descriptions thereof are used to explain the present disclosure, but are not used as limitations of the present disclosure.

The acquisition, storage, use and processing of data in the technical solution of the present disclosure comply with the relevant provisions of laws and regulations.

Through in-situ introduction of reducing gas such as carbon monoxide (CO), in combination with methods such as conductance, electrochemistry, Gas Chromatography (GC), Infrared Spectroscopy (IR) and Raman spectroscopy, the characteristics of the oxygen vacancy can be studied, but these technologies lack sufficient measuring throughput to achieve efficient kinetic detection.

The infrared imaging technology is generally regarded as a high-throughput tool set for studying thermal properties of a material surface, which is widely used in thermal imaging research of a material surface. However, it is more noteworthy that the emissivity of the material surface in the infrared band is closely related to the dielectric properties of the material surface. The infrared imaging technology is not only a measuring technology that is sensitive to the temperature of the material surface, but also a measuring technology that is sensitive to the dielectric state of the material surface. In addition, the infrared imaging technology does not need to introduce an additional excitation light source, and the thermal radiation information of the material itself can reflect the dielectric properties of the material surface intrinsically. In the present disclosure, for the gas-solid interface, the infrared emissivity of the surface of the transition metal oxide changes with the introduction of the atmosphere of reaction gas molecules (CO) at a high temperature. This is because, as reactive gas molecules are combined with surface active oxygen species and are adsorbed on the material surface, the dielectric properties of the material surface are changed, and the emissivity of the material surface in infrared band is changed. Based on this, the present disclosure provides a method of implementing in-situ high-throughput kinetic measurement on gas-solid interface adsorption reaction by using the infrared imaging technology. Fitting of the Langmuir adsorption kinetic model can quantitatively measure the binding kinetics, the dissociation kinetics and equilibrium constants between molecules of the gas-solid interface. For the gas-liquid interface, the surface temperature of alkaline solution changes due to the intense reaction heat after CO₂ gas molecules are introduced into the alkaline solution. Using the principle of the infrared thermal imaging technology, the reaction exothermal kinetic characteristics in the adsorption process may be measured, and the reaction enthalpy information of different CO₂ absorption solution may be accurately quantified through the thermal dissipation kinetic equation. This technology not only provides a new way to efficiently monitor the heterogeneous interface reaction kinetics, but also brings a new perspective for the research in the fields of catalysis, sensing and gas adsorption.

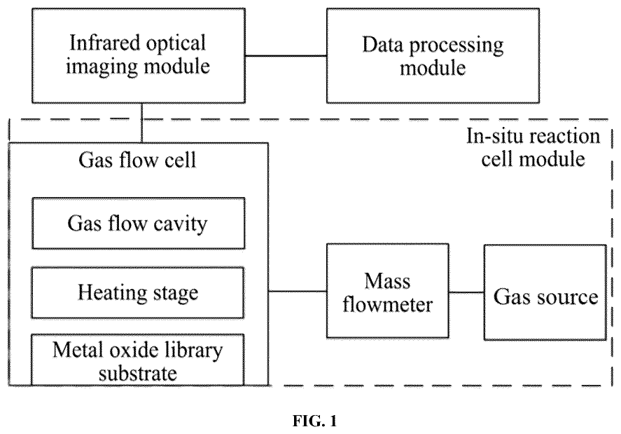

In order to solve the problems in the conventional art, an embodiment of the present disclosure provides an infrared imaging system. FIG. 1 is a schematic diagram of an infrared imaging system according to an embodiment of the present disclosure. As shown in FIG. 1, the infrared imaging system in an embodiment of the present disclosure may include an in-situ reaction cell module, an infrared optical imaging module, and a data processing module.

The in-situ reaction cell module includes an in-situ gas flow cell, a mass flowmeter and a gas source. The in-situ gas flow cell includes a gas flow cavity, a heating stage, and a metal oxide library substrate arranged in the gas flow cavity and placed on the heating stage. The metal oxide library substrate is provided with a plurality of holes into which reaction samples are placed. The reaction sample includes a solid sample or a gas sample. The gas source is configured to deliver reaction gas into the gas flow cavity of the in-situ gas flow cell through the mass flowmeter. The mass flowmeter is configured to control a concentration and a flow rate of the reaction gas. The heating stage is configured to heat the reaction sample.

The infrared optical imaging module is configured to acquire infrared images of a surface of the reaction sample and send the infrared images to the data processing module.

The data processing module is configured to perform data analysis on the received infrared images and extract a kinetic curve from the infrared images.

When the reaction sample is a solid sample, the data processing module is further configured to fit the kinetic curve by using a predetermined adsorption kinetic equation to determine kinetic data of the surface of the reaction sample, and/or fit the kinetic curve by using a thermal dissipation kinetic equation to determine thermodynamic data of the surface of the reaction sample. The kinetic curve is an infrared image intensity curve.

When the reaction sample is a liquid sample, the data processing module is further configured to fit the kinetic curve by using the thermal dissipation kinetic equation to determine the thermodynamic data of the surface of the reaction sample.

In the infrared imaging system provided by the embodiment of the present disclosure, real-time in-situ infrared optical imaging is performed by the infrared optical imaging module, and the data processing module performs data analysis and processing on the image to obtain the adsorption reaction kinetic curve of the heterogeneous interface. For the gas-solid interface adsorption reaction process, the Langmuir kinetic equation is used to perform data fitting to obtain the adsorption reaction kinetic constant and the adsorption reaction equilibrium constant, which can quantitatively measure the binding kinetics, the dissociation kinetics and equilibrium constants between molecules of the gas-solid interface. The adsorption intensity differences between different samples are compared.

For the gas-liquid interface adsorption reaction process, the adsorption reaction enthalpy change is obtained by using the thermal dissipation kinetic equation. According to the temperature change kinetic characteristics, the CO₂ adsorption enthalpy information of different organic amine solution may be accurately quantified by using the thermal dissipation kinetic equation to measure the gas adsorption capacity of the sample. The present disclosure directly utilizes the thermal radiation information of the sample to reflect the surface chemical state and the temperature change characteristics of the sample, and efficiently quantifies interaction between heterogeneous interfaces with a high throughput through kinetic data analysis, which is expected to become a new method for studying the properties of heterogeneous interfaces.

The technical principle and the implementation effect of the present disclosure will be further explained with reference to the drawings and specific embodiments, but the following embodiments are only used to illustrate the present disclosure in detail and do not limit the scope of the present disclosure in any way.

In an embodiment, the in-situ gas flow cell further includes an infrared optical window. The infrared optical window is configured to allow an infrared ray emitted from the surface of the metal oxide sample to exit the in-situ gas flow cell. The infrared optical window is made of a material with a transmittance in a short-wave infrared region greater than a predetermined transmittance. The metal oxide library substrate is located directly below the infrared optical window.

In an embodiment, the infrared optical imaging module includes a short-wave infrared camera. A photosensitive band of the short-wave infrared camera ranges from 0.9 microns to 1.7 microns. The short-wave infrared camera is configured to acquire the infrared images of the surface of the reaction sample without introducing an additional light source.

In an embodiment, the reaction sample may include a solid sample or a liquid sample. In the embodiment of the present disclosure, metal oxide powder is taken as an example of the solid sample, and organic amine alkaline solution is taken as an example of the liquid sample.

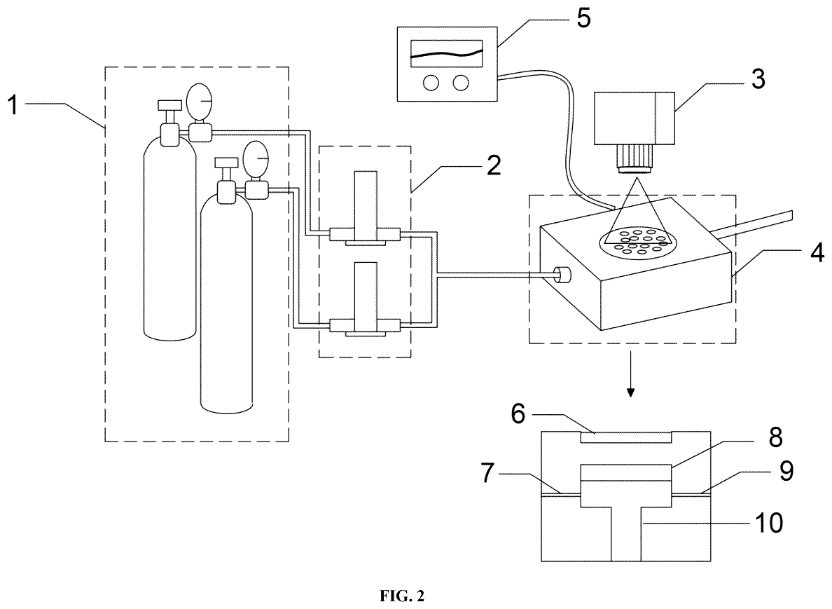

FIG. 2 is a schematic diagram of a specific example of an infrared imaging system according to an embodiment of the present disclosure. As shown in FIG. 2, in an embodiment, the infrared imaging system may specifically include: 1—gas source, 2—mass flowmeter, 3—short-wave infrared camera, 4—in-situ gas flow cell, 5—temperature controller, 6—infrared optical window, 7—thermocouple, 8—metal oxide library substrate, 9—ceramic heating rod, and 10—heating stage body.

In this embodiment, as shown in FIG. 2, the in-situ gas flow cell 4 may be provided with an infrared optical window and a heating stage. The metal oxide library substrate 8 may be made of stainless steel. The heating stage body 10 may be made of copper.

In this embodiment, as shown in FIG. 2, the gas source 1 may include nitrogen and carbon monoxide, in which nitrogen serves as an inert gas to provide an inert atmosphere for the gas flow cell, and carbon monoxide serves as a reaction gas to react with the reaction sample in the metal oxide library substrate. It may be seen that the gas source is further configured to deliver nitrogen or other inert gases into the gas flow cavity of the in-situ gas flow cell.

In an embodiment, the gas flow cavity is provided with a gas inlet and a gas outlet. The gas source is delivered to the gas flow cavity through the mass flowmeter and the gas inlet in sequence. The gas outlet is connected with a tail gas treatment module. The tail gas treatment module is configured to store and process the acquired gas. The in-situ gas flow cell is configured to provide a reaction channel for the reaction gas and the reaction sample.

In this embodiment, as shown in FIG. 2, the mass flowmeter 2 is connected between the gas source 1 and the in-situ gas flow cell 4, and is connected with the in-situ gas flow cell 4 through the gas inlet. The mass flowmeter 2 provides two control apparatuses which control nitrogen and carbon monoxide in the gas source 1, respectively. The control apparatuses may be valves. The mass flowmeter 2 functions to control the concentration and the flow rate of inert gas and/or reaction gas. The gas source is delivered to the gas flow cavity through the mass flowmeter and the gas inlet in sequence, and flows out of the gas outlet. The gas outlet is connected with a tail gas treatment module (not shown in FIG. 2). The tail gas treatment module is configured to store and process the acquired gas. The in-situ gas flow cell is configured to provide a reaction channel for the reaction gas and the reaction sample, and also to maintain and control the reaction temperature of the reaction sample.

In an embodiment, as shown in FIG. 2, the infrared optical imaging module may include a short-wave infrared camera 3. The in-situ gas flow cell 4 may further include an infrared optical window 6. The short-wave infrared camera 3 acquires the infrared images of the surface of the reaction sample placed in the metal oxide library substrate 8 located directly below the infrared optical window 6 through the infrared optical window 6.

The infrared optical window 6 may be made of sapphire (Al₂O₃) with a transmittance in a short-wave infrared region greater than a predetermined transmittance. The wavelength range of the short-wave infrared region is from 0.9 microns to 1.7 microns. Optical glass made of quartz that may penetrate through the short-wave infrared band can also be selected.

In an embodiment, the data processing module is configured to perform data analysis and kinetic model fitting on the received infrared images. The infrared optical imaging module shoots the surface of each sample in the heterogeneous interface adsorption reaction kinetic process in a delayed manner, to obtain infrared optical time sequence images. The data processing module extracts the kinetic curve of the infrared response of the sample surface, which is used for the analysis of different kinetic models.

In an embodiment, the data processing module is specifically configured to extract the infrared signal response kinetic curve of each sample surface in the infrared image according to the time sequence; for the gas-solid reaction system, perform kinetic data fitting on each curve by using the Langmuir adsorption kinetic equation or the heat dissipation kinetic equation to extract the kinetic rate constant of the gas-solid interface adsorption reaction; and for the gas-liquid reaction system, perform data fitting on each curve by using the thermal dissipation kinetic equation, and calculate and obtain the gas-liquid adsorption reaction enthalpy.

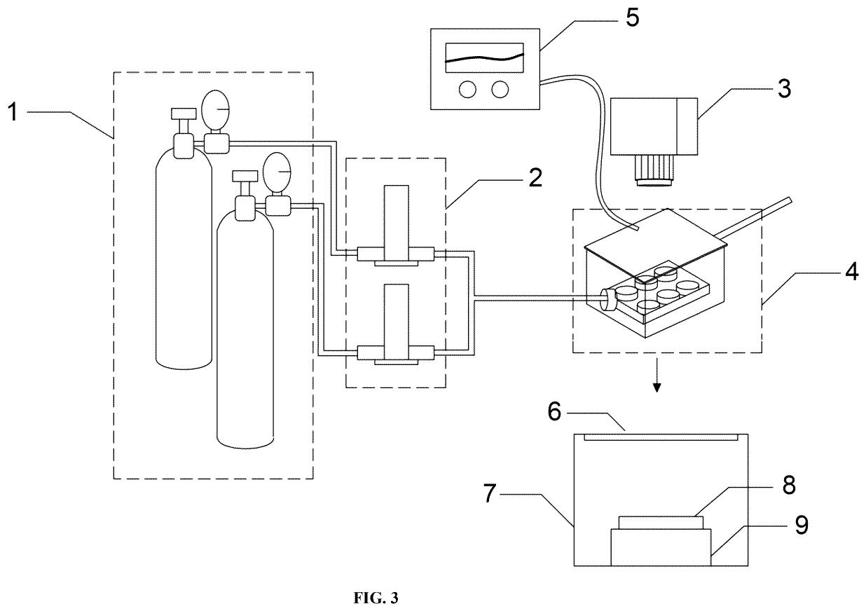

FIG. 3 is a schematic diagram of another specific example of an infrared imaging system according to an embodiment of the present disclosure. As shown in FIG. 3, the structure of the in-situ gas flow cell is further introduced below.

The in-situ gas flow cell includes a heating stage (7, 9, and 10 in FIG. 3 denote parts of the heating stage, respectively) and a metal oxide library substrate 8 arranged in the gas flow cavity (not shown in FIG. 3) and placed on the heating stage.

In an embodiment, the heating stage is made of brass with thermal conductivity higher than predetermined thermal conductivity. The heating stage includes a ceramic heating rod and a thermocouple. The ceramic heating rod and the thermocouple are configured to heat or cool the reaction sample in the metal oxide library substrate to a predetermined temperature or maintain a constant temperature.

In this embodiment, as shown in FIG. 2, the heating stage body 10 may be a heating stage made of copper. The heating stage can further include a ceramic heating rod 9 and a thermocouple 7. The ceramic heating rod 9 and the thermocouple 7 are configured to heat or cool the reaction sample in the metal oxide library substrate to a predetermined temperature or maintain a constant temperature.

In an embodiment, as shown in FIG. 2, the infrared imaging system may further include a temperature controller 5. The temperature controller 5 is connected with the ceramic heating rod 9 for controlling the ceramic heating rod 9, so as to control the rise and fall of temperature of the heating stage.

In an embodiment, the metal oxide library substrate is inert to the reaction gas. An infrared emissivity of the metal oxide library substrate is lower than a predetermined infrared emissivity. A thermal conductivity of the metal oxide library substrate is higher than a predetermined thermal conductivity.

The metal oxide library substrate has an infrared response which is inert to the reaction gas, and should have a low infrared emissivity and a good thermal conductivity. Taking the kinetic test of carbon monoxide gas and reaction samples as an example, the metal oxide library substrate may be made of stainless steel with chrome plated surface. The metal oxide library substrate is used for holding a plurality of types of metal oxide powder. Taking the thermodynamic test of the reaction between CO₂ gas and alkaline solution as an example, the used liquid template (the metal oxide library substrate) has a low infrared emissivity.

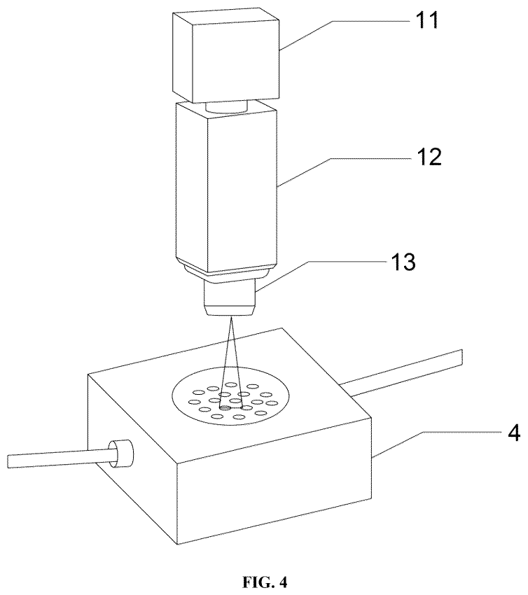

In order to further study the changes of infrared emission spectrum in the adsorption-desorption process of the material surface and gas molecules, the foregoing infrared imaging system is modified as follows: a short-wave infrared (spectroscopic) spectrometer compatible with the imaging band of the short-wave infrared camera is connected to the front interface of the short-wave infrared camera, and an infrared optical lens is equipped to gather and collect infrared spectral lines emitted from the metal oxide surface. FIG. 4 is a schematic diagram of an infrared optical imaging module according to an embodiment of the present disclosure. As shown in FIG. 4, in an embodiment, the infrared optical imaging module may include a short-wave infrared camera 11, a short-wave infrared spectrometer 12 and an infrared optical lens 13. An imaging band of the short-wave infrared spectrometer 12 is matched with the short-wave infrared camera 11. The photosensitive band of the short-wave infrared camera 11 ranges from 0.9 microns to 1.7 microns. The infrared optical lens 13 is configured to acquire an infrared ray emitted from the surface of the reaction sample. The short-wave infrared spectrometer 12 is configured to generate an infrared image according to the infrared ray acquired by the infrared optical lens 13 and project the infrared image to the short-wave infrared camera 11.

In this embodiment, the photosensitive band of the short-wave infrared camera ranges from 0.9 microns to 1.7 microns. Most gas molecules may be regarded as infrared radiation penetrable substance in this band, that is, the transmittance of the infrared ray may be regarded as 100%. The short-wave infrared camera may directly image the heated reaction sample without introducing an additional light source.

In an embodiment, as shown in FIG. 4, in addition to directly using the short-wave infrared camera 11, a short-wave infrared spectrometer 12 matched with the imaging band may be connected in front of the short-wave infrared camera 11 for infrared spectral imaging analysis, and an infrared optical lens 13 may be continuously connected to collect an infrared ray emitted from the surface of metal oxide powder. The short-wave infrared spectrometer 12 can be used to further record the time sequence spectrogram of the infrared spectrum on the surface of the reaction sample in the gas-solid interface reaction kinetic process. The time sequence spectrogram is sent to the data processing module for data analysis, which can further parse the infrared emissivity change and the temperature change of the surface of metal oxide materials in the reaction kinetic process.

In order to achieve in-situ online kinetic evolution observation, in an embodiment, the infrared optical imaging module is specifically configured to shoot in a delayed manner according to a predetermined frame rate to acquire infrared images. The infrared images are an image sequence. The infrared images are sent to the data processing module according to a time sequence.

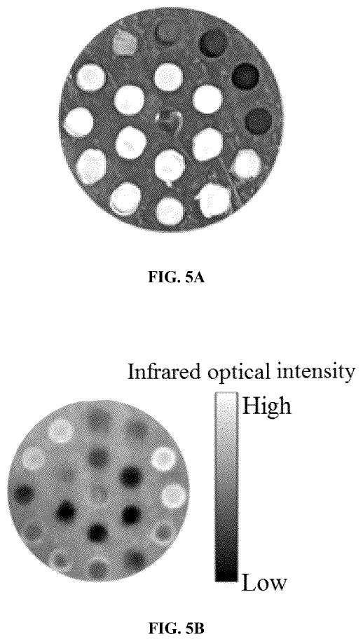

FIG. 5A is a bright-field image of a metal oxide library substrate in which a plurality of reaction samples are placed at a specific moment according to an embodiment of the present disclosure, and FIG. 5B is an infrared image of a metal oxide library substrate in which a plurality of reaction samples are placed at a specific moment according to an embodiment of the present disclosure. As shown in FIG. 5A, stainless steel with a low infrared emissivity is used as the metal oxide library substrate, and about 1 mg of metal oxide powder is filled in the holes of the substrate. A short-wave infrared (0.9 microns to 1.6 microns) camera is used to monitor the infrared signal changes of samples in the metal oxide library substrate in the high-temperature in-situ gas flow cell. As shown in FIG. 5B, the short-wave infrared imaging diagram shows that there are significant differences in infrared optical intensity among various reaction samples under the condition of thermal equilibrium. The darker the color, the lower the infrared optical intensity of the reaction sample.

In an embodiment, when the reaction sample is a solid sample, the data processing module is specifically configured to: extract the kinetic curve of the surface of the reaction sample in the infrared images according to the time sequence; where the kinetic curve includes an adsorption kinetic curve and a desorption kinetic curve; the adsorption kinetic curve is an infrared image intensity curve in a process of adsorbing the reaction gas to the surface of the reaction sample; and the desorption kinetic curve is an infrared image intensity curve in a process of desorbing the reaction gas from the surface of the reaction sample; fit the kinetic curve by using the predetermined adsorption kinetic equation to determine a kinetic rate constant for the adsorption process and a kinetic rate constant for the desorption process; where the predetermined adsorption kinetic equation is determined by a Langmuir adsorption law; and determine an equilibrium constant of gas-solid interface reaction according to the kinetic rate constant of the adsorption process and the kinetic rate constant of the desorption process.

In this embodiment, the infrared optical imaging module is used to directly perform infrared imaging on the gas-solid interface reaction process with a high throughput. The gas-solid interface reaction process mainly includes (taking the reaction kinetic process of carbon monoxide as an example):
starting to shoot in a delayed manner at a specific frame rate by the infrared optical imaging module, to capture the infrared image of the reaction sample in the inert nitrogen atmosphere as a baseline of the kinetic curve;
starting a gas adsorption process, and switching the nitrogen atmosphere to a carbon monoxide gas atmosphere with a specific concentration;
when the surface of the metal oxide powder in the metal oxide library reaches the adsorption saturation, switching the CO gas atmosphere with a specific concentration to the nitrogen atmosphere, such that the CO molecules adsorbed on the surface start to desorb till the desorption is complete and the surface of the metal oxide powder is restored to the initial state; and
sending the captured infrared images to the data processing module in time sequence and extracting the kinetic curve.

In an embodiment, the predetermined adsorption kinetic equation is:

$$\begin{matrix}{R}_{t} = {a}_{0} \frac{1 - exp ( - {k}_{L} t )}{1 - Q exp ( - {k}_{L} t )} ( {a}_{0} = {θ}_{e} \frac{Δ {ε}_{m}}{{ε}_{0}} ) ; \\ {k}_{L} = ( 1 - Q ) \frac{{k}_{a} {p}_{i}}{{θ}_{e}} ;\end{matrix}$$

where Rₜ is a response value of an infrared signal; Q reflects a weight contributed by a pseudo-first-order kinetic model and a pseudo-second-order kinetic model, when the value of Q approaches 0, the adsorption kinetic characteristics show pseudo-first-order kinetic characteristics, and when the value of Q approaches 1, the adsorption kinetic characteristics show pseudo-second-order kinetic characteristics; t is the time; kₐ is an intrinsic adsorption kinetic constant; pᵢ is a partial pressure of adsorbate gas; θₑ is an equilibrium adsorption coverage; Δεₘ is a change value of infrared emissivity when the surface of the reaction sample reaches the maximum adsorption state; and co is an initial infrared emissivity of a site on the surface of the reaction sample.

The data processing module extracts the infrared signal intensity of the surface of each reaction sample in the time sequence image shot by the infrared optical imaging module and obtains the gas-solid interface reaction kinetic curve. The Langmuir kinetic model is used to perform data fitting to obtain the kinetic rate constant of the adsorption process and the kinetic rate constant of the desorption process. The kinetic characteristics are determined according to the fitting parameters. According to the fit adsorption kinetic rate constant and desorption kinetic rate constant, the gas-solid interface reaction equilibrium constant may be obtained.

In an embodiment, the data processing module is further configured to: parse the infrared images collected by an infrared spectrometer and projected on an infrared camera into an infrared spectrogram; perform data fitting on the infrared spectrogram by using a predetermined Planck blackbody radiation equation, and determine emissivity change characteristics and temperature change characteristics of the surface of the reaction sample; where the predetermined Planck blackbody radiation equation is determined by a Planck's blackbody radiation law.

The data processing module parses the infrared images collected by the short-wave infrared spectrometer and projected on the short-wave infrared camera into an infrared spectrogram; perform data fitting on the infrared spectrogram of time sequence by using a Planck blackbody radiation data model, and further parses out change characteristics of the emissivity and the temperature of the materials surface in the reaction kinetic process.

Compared with the technical solution of the oxygen vacancy feature detection of the metal oxide surface in the conventional art, according to the embodiment of the present disclosure, an infrared imaging system includes: an in-situ reaction cell module, an infrared optical imaging module, and a data processing module; where the in-situ reaction cell module includes an in-situ gas flow cell, a mass flowmeter and a gas source; the in-situ gas flow cell includes a gas flow cavity, a heating stage, and a metal oxide library substrate arranged in the gas flow cavity and placed on the heating stage; the metal oxide library substrate is provided with a plurality of holes into which reaction samples are placed; the reaction sample includes a solid sample or a gas sample; the gas source is configured to deliver reaction gas into the gas flow cavity of the in-situ gas flow cell through the mass flowmeter; the mass flowmeter is configured to control a concentration and a flow rate of the reaction gas; the heating stage is configured to heat the reaction sample; the infrared optical imaging module is configured to acquire infrared images of a surface of the reaction sample and send the infrared images to the data processing module; the data processing module is configured to perform data analysis on the infrared images received and extract a kinetic curve from the infrared images; when the reaction sample is a solid sample, the data processing module is further configured to fit the kinetic curve by using a predetermined adsorption kinetic equation to determine kinetic data of the surface of the reaction sample, and/or fit the kinetic curve by using a thermal dissipation kinetic equation to determine thermodynamic data of the surface of the reaction sample; where the kinetic curve is an infrared image intensity curve; and when the reaction sample is a liquid sample, the data processing module is further configured to fit the kinetic curve by using the thermal dissipation kinetic equation to determine the thermodynamic data of the surface of the reaction sample, which may efficiently quantify interaction between heterogeneous interfaces with a high throughput, achieve reaction kinetic measurement between a metal oxide surface and a gas molecule, and screen out a high-performance CO₂ absorbent from a large number of potential excellent absorbent formulations.

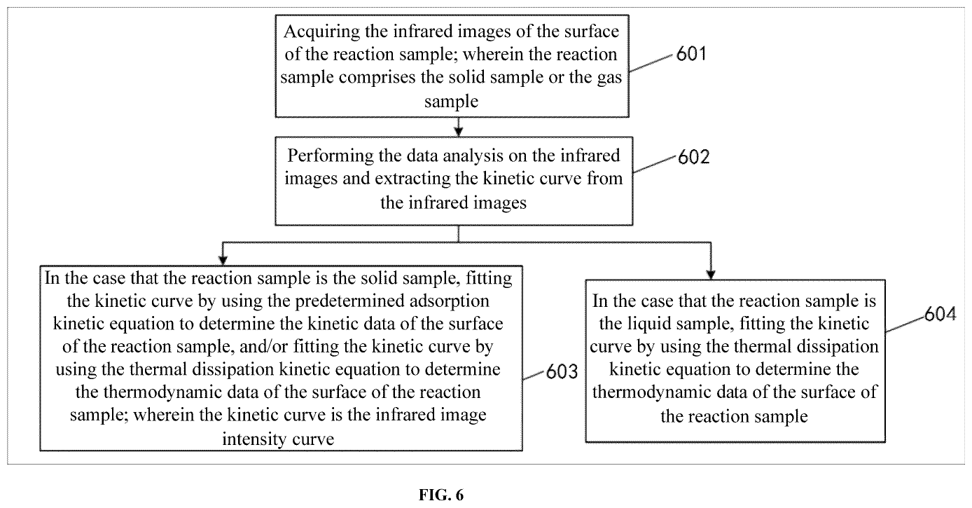

In order to efficiently implement in-situ high-throughput reaction kinetic measurement of gas molecules on the surface of transition metal oxides, the embodiment of the present disclosure further provides a detection method based on an infrared imaging system, which is applied to the foregoing infrared imaging system. FIG. 6 is a flowchart of a detection method based on an infrared imaging system according to an embodiment of the present disclosure. As shown in FIG. 6, the detection method based on the infrared imaging system may include steps 601-604.

In step 601, the infrared images of a surface of a reaction sample are acquired; where the reaction sample includes a solid sample or a gas sample.

In step 602, the data analysis is performed on the infrared images and a kinetic curve is extracted from the infrared images.

In step 603, when the reaction sample is a solid sample, the kinetic curve is fitted by using a predetermined adsorption kinetic equation to determine kinetic data of the surface of the reaction sample, and/or the kinetic curve is fitted by using a thermal dissipation kinetic equation to determine thermodynamic data of the surface of the reaction sample; where the kinetic curve is an infrared image intensity curve.

In step 604, when the reaction sample is a liquid sample, the kinetic curve is fitted by using the thermal dissipation kinetic equation to determine the thermodynamic data of the surface of the reaction sample.

In step 601, the infrared images of the surface of the reaction sample are obtained by using the infrared optical imaging module in the infrared imaging system.

In an embodiment, performing data analysis on the infrared images and extracting a kinetic curve from the infrared images may include: extracting the kinetic curve of the surface of the reaction sample in the infrared images according to the time sequence; where the kinetic curve includes an adsorption kinetic curve and a desorption kinetic curve; the adsorption kinetic curve is an infrared image intensity curve in a process of adsorbing the reaction gas to the surface of the reaction sample; and the desorption kinetic curve is an infrared image intensity curve in a process of desorbing the reaction gas from the surface of the reaction sample.

In this embodiment, when the reaction sample is a solid sample, fitting the kinetic curve by using a predetermined adsorption kinetic equation to determine kinetic data of the surface of the reaction sample may include: fitting the kinetic curve by using the predetermined adsorption kinetic equation to determine a kinetic rate constant of the adsorption process and a kinetic rate constant of the desorption process; where the predetermined adsorption kinetic equation is determined by a Langmuir adsorption law; and determining an equilibrium constant of gas-solid interface reaction according to the kinetic rate constant of the adsorption process and the kinetic rate constant of the desorption process.

In this embodiment, when the reaction sample is a solid sample, fitting the kinetic curve by using a predetermined adsorption kinetic equation to determine kinetic data of the surface of the reaction sample includes: fitting the kinetic curve by using the predetermined adsorption kinetic equation to determine a kinetic rate constant of the adsorption process and a kinetic rate constant of the desorption process; and determining an equilibrium constant of gas-solid interface reaction according to the kinetic rate constant of the adsorption process and the kinetic rate constant of the desorption process.

In an embodiment, the predetermined adsorption kinetic equation is:

$$\begin{matrix}{R}_{t} = {a}_{0} \frac{1 - exp ( - {k}_{L} t )}{1 - Q exp ( - {k}_{L} t )} ( {a}_{0} = {θ}_{e} \frac{Δ {ε}_{m}}{{ε}_{0}} ) ; \\ {k}_{L} = ( 1 - Q ) \frac{{k}_{a} {p}_{i}}{{θ}_{e}} ;\end{matrix}$$

where Rₜ is a response value of an infrared signal; Q reflects a weight contributed by a pseudo-first-order kinetic model and a pseudo-second-order kinetic model, when the value of Q approaches 0, the adsorption kinetic characteristics show pseudo-first-order kinetic characteristics, and when the value of Q approaches 1, the adsorption kinetic characteristics show pseudo-second-order kinetic characteristics; t is the time; kₐ is an intrinsic adsorption kinetic constant; pᵢ is a partial pressure of adsorbate gas; θₑ is an equilibrium adsorption coverage; Δεₘ is a change value of infrared emissivity when the surface of the reaction sample reaches the maximum adsorption state; and ε₀ is an initial infrared emissivity of a site on the surface of the reaction sample.

In an embodiment, the detection method based on the infrared imaging system may further include: parsing the infrared image into an infrared spectrogram; and performing data fitting on the infrared spectrogram by using a predetermined Planck blackbody radiation equation, and determining emissivity change characteristics and temperature change characteristics of the surface of the reaction sample; where the predetermined Planck blackbody radiation equation is determined by a Planck's blackbody radiation law.

According to the Planck's blackbody radiation law, it may be known that the infrared radiant exitance E_{λT,ε} of an object follows the following equation:

$${E}_{λ , T , ε} = {ε}_{em} \frac{{C}_{1}}{{λ}^{5}} \frac{1}{{e}^{\frac{{C}_{2}}{λ T}} - 1} ( {ε}_{em} < 1 ) ;$$

where εₑₘ is the infrared emissivity of the object surface; ε is a dielectric constant of the object in the infrared band; C₁ and C₂ are constants, λ is a wavelength, and T is the absolute temperature.

Therefore, under isothermal conditions, the infrared emission intensity of an object is related to the surface infrared emissivity of the object in a specific wavelength range. The difference of the surface infrared emissivity of different materials may be explained according to the dielectric mechanism, that is, the infrared emissivity of different materials and the surface dielectric properties of different materials satisfy the following equation:

$${ε}_{em} = 1 - {( 1 - \frac{2}{\sqrt{ε} + 1} )}^{2} ;$$

where εₑₘ is the infrared emissivity of the object surface, and ε is a dielectric constant of the object in the infrared band.

Transition metal oxides are semiconductor materials widely used in many fields. A dielectric property is a key parameter in the research of semiconductor materials, which is closely related to the concentration and the mobility of carriers. Many research results have pointed out that surface oxygen vacancy defects have a significant impact on the electronic structure and the charge transfer characteristics of semiconductors. Especially, when the oxygen vacancy on the metal oxide surface is occupied by actively adsorbed oxygen and reacts with reducing gas such as carbon monoxide (CO), the local electronic structure and dielectric properties may be changed, which may further affect the infrared emissivity of materials.

In an embodiment, the infrared camera can directly perform infrared imaging on each metal oxide powder in the metal oxide library. In the process of reaction between the introduced reaction gas and the sample to be tested in the in-situ reaction cell, the infrared ray on the surface of the sample passes through the infrared optical window and is collected and imaged on the infrared camera. The concentration and the flow rate of the reaction atmosphere are controlled by the mass flowmeter.

The reaction kinetic measurement between CO gas molecules and metal oxide powder is used as a specific example. When the reaction gas, namely carbon monoxide, is introduced into the in-situ reaction cell, the infrared intensity of the surface of the metal oxide responds due to the change in surface emissivity resulted from the reaction between CO gas molecules and the surface of the metal oxide. The infrared response characteristics of the surface of the metal oxide can be recorded in real-time by an infrared camera. The specific experimental operation steps are as follows.

Step 1), the about 1 mg of metal oxide samples are filled into each hole of a metal oxide library substrate, the metal oxide library substrate are placed on a heating stage, and the in-situ gas flow cell is packaged.

Step 2), the mass flowmeter is turned on and the nitrogen atmosphere is introduced at a specific flow rate to purge the in-situ gas flow cell until the in-situ gas flow cell has a pure nitrogen inert atmosphere, and the heating stage and the temperature control system are turned on to heat the metal oxide sample to the specified reaction temperature at a certain heating rate.

Step 3), the metal oxide sample is kept at the reaction temperature, the short-wave infrared camera is turned on to start shooting in a delay manner with a specific shooting frequency, and the intensity of the infrared image recorded at this time is taken as the intensity baseline.

Step 4), in the gas adsorption process, the inert atmosphere in the in-situ gas flow cell is switched to a CO gas atmosphere with a specific concentration, carbon monoxide gas molecules start to be adsorbed on the surface of the metal oxide sample, the infrared signal intensity starts to respond with time, and the intensity curve of this recorded infrared image is an adsorption kinetic curve.

Step 5), in gas desorption process, the pure nitrogen atmosphere is introduced to purge carbon monoxide gas molecules in the in-situ gas flow cell and on the surface of the metal oxide sample, with the decrease of the partial pressure of carbon monoxide gas, carbon monoxide molecules adsorbed on the surface of the metal oxide start to be desorbed, and the infrared signal intensity starts to recover to the initial baseline intensity, and the intensity curve of this recorded infrared image is a desorption kinetic curve. This step further includes the regeneration process of the metal oxide surface, that is, the purging is continuously performed with the nitrogen atmosphere and the temperature is increased to accelerate the gas desorption rate until the gas molecules adsorbed on the metal oxide surface are completely desorbed.

Step 6), Step 3) to Step 5) is taken as a test cycle, and several cycles are repeated.

Step 7), the data fitting is performed on the infrared response kinetic curve of the surface of each metal oxide powder in the infrared images recorded in Step 3) to Step 6) by using the Langmuir kinetic model.

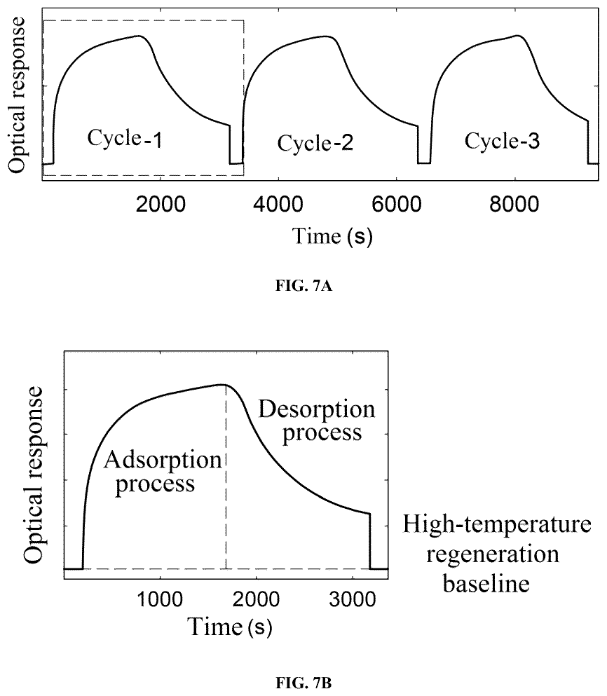

Taking the reaction kinetic characteristics of zinc oxide powder and carbon monoxide molecules as an example, experiments are carried out according to the above steps for a plurality of cycles. FIG. 7A is a reaction kinetic curve in a plurality of cycles of adsorption and desorption of carbon monoxide molecules on and from surfaces of zinc oxide powder according to an embodiment of the present disclosure. As shown in FIG. 7A, zinc oxide powder shows good repeatability in a plurality of cycles of adsorption and desorption. The reaction kinetic curve for the cycles of adsorption and desorption is a relationship diagram between optical response (dimensionless) and time, and the example of FIG. 7A is cycle-1 to cycle-3. FIG. 7B is an enlarged view of a part of the reaction kinetic curve in the plurality of cycles of adsorption and desorption of carbon monoxide molecules on and from surfaces of zinc oxide powder, according to an embodiment of the present disclosure. As shown in FIG. 7B, the rising part of the curve in the cycle-1 is the adsorption process, the falling part is the desorption process, and the part where the optical response levels off after 3000s is the high-temperature regeneration baseline.

In an embodiment, the detection method based on the infrared imaging system further includes:
determining the predetermined adsorption kinetic equation according to a Langmuir adsorption law.

In an embodiment, the predetermined adsorption kinetic equation is:

$$\begin{matrix}{R}_{t} = {a}_{0} \frac{1 - exp ( - {k}_{L} t )}{1 - Q exp ( - {k}_{L} t )} ( {a}_{0} = {θ}_{e} \frac{Δ {ε}_{m}}{{ε}_{0}} ) ; \\ {k}_{L} = ( 1 - Q ) \frac{{k}_{a} {p}_{i}}{{θ}_{e}} ;\end{matrix}$$

where Rₜ is a response value of an infrared signal; Q reflects a weight contributed by a pseudo-first-order kinetic model and a pseudo-second-order kinetic model, when the value of Q approaches 0, the adsorption kinetic characteristics show pseudo-first-order kinetic characteristics, and when the value of Q approaches 1, the adsorption kinetic characteristics show pseudo-second-order kinetic characteristics; t is the time; kₐ is an intrinsic adsorption kinetic constant; pᵢ is a partial pressure of adsorbate gas; θₑ is an equilibrium adsorption coverage; Δεₘ is a change value of infrared emissivity when the surface of the reaction sample reaches the maximum adsorption state; and ε₀ is an initial infrared emissivity of a site on the surface of the reaction sample.

In an embodiment, after the kinetic curve is extracted from the infrared images, different analysis methods may be used for the kinetic curve according to the difference between the gas-solid interface reaction system and the gas-liquid reaction system.

For the gas-solid interface reaction system, batch fitting of the Langmuir kinetic model is performed on the extracted infrared response kinetic curves to obtain the adsorption-desorption reaction kinetic rate constant and the reaction equilibrium constant; and for the gas-liquid reaction system, batch fitting of the thermal dissipation kinetic model is performed on the extracted infrared response kinetic curves, and the reaction enthalpy is further calculated.

In an embodiment, the Langmuir adsorption law is widely used to describe the chemical adsorption process of the multiphase interface, and the adsorption reaction equation of the adsorption process is:

$$A + B ↔ AB , \qquad ( 1 )$$

where A, B, and AB denote an adsorption molecule, an adsorption site, and an adsorption bound substance, respectively. According to the Langmuir adsorption, it is assumed that all adsorption sites on the material surface are equivalent, and there is no interaction between adsorbate molecules, so that the material surface may be divided into several independent adsorption sites. When gas molecules occupy the adsorption sites on the material surface, it is assumed that the initial infrared emissivity of the site is ε₀, and the infrared emissivity after gas molecules are adsorbed becomes εᵢ, so that the adsorption coverage θₙ of gas molecules on the material surface may be described as:

$${θ}_{n} = \frac{n ( {ε}_{i} - {ε}_{0} )}{m ( {ε}_{i} - {ε}_{0} )} = \frac{Δ {ε}_{n}}{Δ {ε}_{m}} , \qquad ( 2 )$$

where n denotes the number of adsorption vacancies occupied by adsorption molecules, m denotes the total number of adsorption vacancies on the material surface, Δεₙ denotes the change value of the infrared emissivity on the material surface, and Δεₘ denotes the change value of the infrared emissivity when the material surface reaches the maximum adsorption state. The response value Rₜ of the infrared signal has the following relationship with the gas molecular coverage θₜ:

$${R}_{t} = \frac{\vert Δ {I}_{t} \vert}{{I}_{0}} = \frac{\vert {Δε}_{t} \vert}{{ε}_{0}} = \frac{Δ {ε}_{m}}{{ε}_{0}} {θ}_{t} . \qquad ( 3 )$$

The differential equation of the gas-solid interface adsorption kinetics has the following form:

$$\frac{d θ}{dt} = 1 - Q [ ( \frac{{k}_{a} {p}_{i}}{{θ}_{e}} ) ( {θ}_{e} - θ ) ] + Q [ ( \frac{{k}_{a} {p}_{i}}{{θ}_{e}^{2}} ) {( {θ}_{e} - θ )}^{2} ] , \qquad ( 4 )$$

where Q reflects a weight contributed by a pseudo-first-order kinetic model and a pseudo-second-order kinetic model, when the value of Q approaches 0, the adsorption kinetic characteristics show pseudo-first-order kinetic characteristics as a whole, and when the value of Q approaches 1, the adsorption kinetic characteristics show pseudo-second-order kinetic characteristics; ε₀ is an initial infrared emissivity of a site on the surface of the reaction sample; ΔIₜ is the change value of the infrared optical intensity with time; Δεₜ is the change value of the infrared emissivity with time; I₀ is the infrared optical intensity in the initial state; kₐ is an intrinsic adsorption kinetic constant; pᵢ is a partial pressure of adsorbate gas; θₑ is an equilibrium adsorption coverage; and Δεₘ is a change value of infrared emissivity when the surface of the reaction sample reaches the maximum adsorption state.

The apparent pseudo first-order kinetic constant is expressed as k₁=kₐpᵢ/θₑ, and the apparent pseudo second-order kinetic constant is expressed as k₂=kₐpᵢ/θₑ², where kₐ is an intrinsic adsorption kinetic constant, pᵢ is a partial pressure, θ and θₑ are the adsorption coverage and the equilibrium adsorption coverage, respectively, and t is the time. The integral of the above equation is:

$$θ = {θ}_{e} \frac{1 - exp ( - {k}_{L} t )}{1 - Q exp ( - {k}_{L} t )} , \qquad ( 5 )$$

$$where$$

$${k}_{L} = ( 1 - Q ) \frac{{k}_{a} {p}_{i}}{{θ}_{e}} . \qquad ( 6 )$$

The Langmuir kinetic equation (5) is substituted into the equation (3) to obtain the adsorption kinetic equation related to the infrared optical response value:

$${R}_{t} = {a}_{0} \frac{1 - exp ( - {k}_{L} t )}{1 - Q exp ( - {k}_{L} t )} ( {a}_{0} = {θ}_{e} \frac{Δ {ε}_{m}}{{ε}_{0}} ) . \qquad ( 7 )$$

The kinetic curve involved in the present disclosure uses the mathematical model of the above equation (7) for fitting. The adsorption kinetic constant kₐ and the desorption kinetic constant k_{d} may be obtained by performing kinetic fitting on the adsorption process and the desorption process, respectively.

In an embodiment, the apparent pseudo-first-order kinetic constant k₁ of the adsorption process measured experimentally depends on the gas partial pressure pᵢ,

$${k}_{1} = \frac{{k}_{a} {p}_{i}}{{θ}_{e}} = {k}_{a} {p}_{i} + {k}_{d} . \qquad ( 8 )$$

The response kinetic constant for the desorption process is k₁′=k_{d}. In order to accurately measure the adsorption kinetic constant kₐ and the desorption kinetic constant k_{d} of gas on the material surface, the embodiment of the present disclosure tests the adsorption-desorption response kinetic constant of the metal oxide surface under different gas partial pressures.

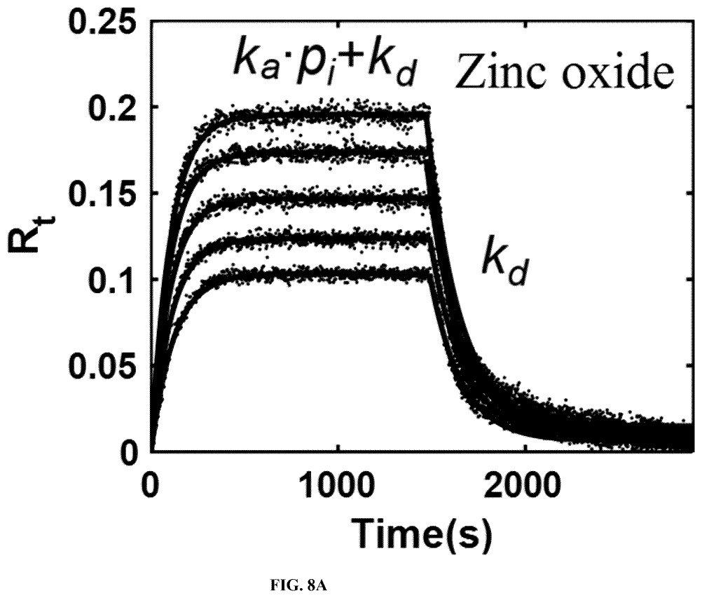

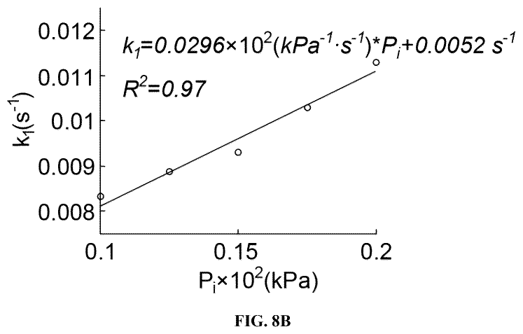

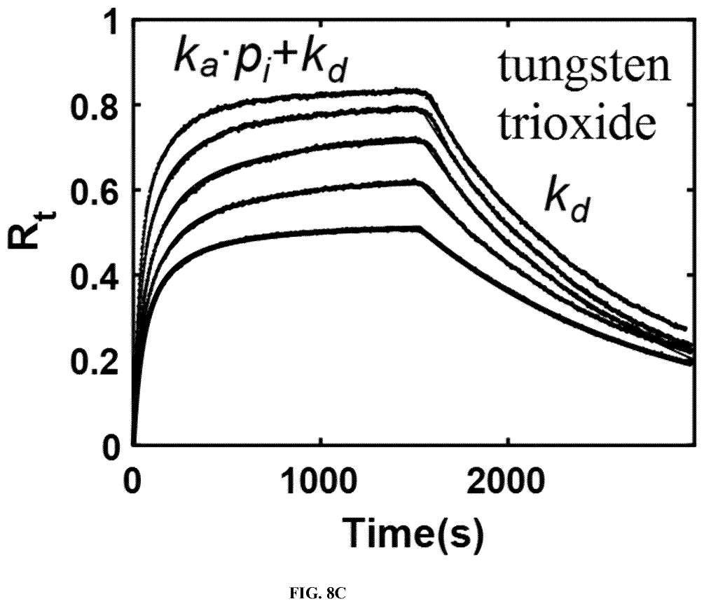

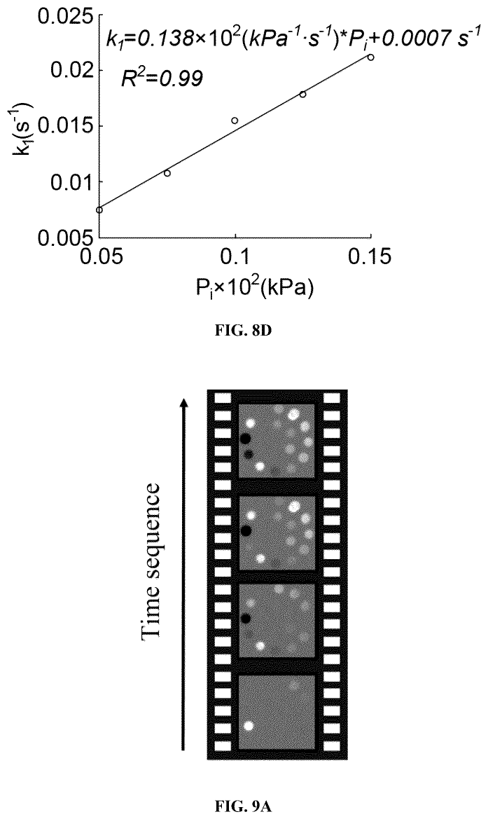

FIG. 8A is a diagram of kinetic curves of a surface of zinc oxide powder according to an embodiment of the present disclosure. FIG. 8B is a diagram of correlation between an apparent response kinetic constant of a surface of zinc oxide powder and a partial pressure of carbon monoxide gas according to an embodiment of the present disclosure. FIG. 8C is a diagram of kinetic curves of a surface of tungsten trioxide powder according to an embodiment of the present disclosure. FIG. 8D is a diagram of correlation between an apparent response kinetic constant of a surface of tungsten trioxide powder and a partial pressure of carbon monoxide gas according to an embodiment of the present disclosure. As shown in FIGS. 8A-8D, the apparent response kinetic constant k₁ of zinc oxide (ZnO) and tungsten trioxide (WO₃) in the adsorption process linearly depends on the gas partial pressure pᵢ at different partial pressures of carbon monoxide gas. The fitting results of the corresponding Langmuir kinetic equation are shown in Table 1 below.

TABLE 1

| | | | k₁ = kₐ × pᵢ + | | | |
|---|---|---|---|---|---|---|
| | pᵢ × 102 | | +k_{d} | k^{'}₁ = k_{d} (s⁻¹) × | kₐ(kPa⁻¹s⁻¹) × | K(kPa⁻¹) × |
| Sample | (kPa) | Q | (s⁻¹) | 10⁻³ | 10⁻⁴ | 10⁻² |
| zinc oxide | 0.100 | 3.22E−08 | 8.32E−03 | 5.86 | 2.45 | 4.18 |
| (ZnO) | 0.125 | 2.68E−09 | 8.87E−03 | 5.80 | 2.46 | 4.25 |
| | 0.150 | 5.74E−07 | 9.31E−03 | 5.67 | 2.42 | 4.27 |
| | 0.175 | 1.02E−08 | 1.03E−02 | 5.85 | 2.53 | 4.32 |
| | 0.200 | 4.69E−07 | 1.13E−02 | 5.87 | 2.7 | 4.6 |
| mean | | 0 | | 5.81 ± 0.08 | 2.51 ± 0.11 | 4.32 ± 0.16 |
| value | | | | | | |
| tungsten | 0.050 | 0.928 | 7.48E−03 | 0.986 | 12.98 | 131.7 |
| trioxide | 0.075 | 0.997 | 1.08E−02 | 0.994 | 13.06 | 131.4 |
| (WO₃) | 0.100 | 0.997 | 1.55E−02 | 1.147 | 14.31 | 124.8 |
| | 0.125 | 0.997 | 1.79E−02 | 1.044 | 13.48 | 129.1 |
| | 0.150 | 0.949 | 2.12E−02 | 1.069 | 13.43 | 125.6 |
| mean | | 0.97 | | 1.05 ± 0.07 | 13.5 ± 0.5 | 128.5 ± 3.2 |
| value | | | | | | |

For the equilibrium adsorption process, the equilibrium adsorption intensity constant K may be defined as:

$$K = \frac{{k}_{a}}{{k}_{d}} . \qquad ( 9 )$$

According to the experimental results in Table 1, the fitting parameter Q of zinc oxide (ZnO) approaches 0, showing a typical first-order adsorption kinetic behavior, while the fitting parameter Q of tungsten trioxide (WO₃) approaches 1, showing a typical second-order adsorption kinetic behavior. The kinetic measurement results show that the response kinetic constant of the adsorption process is linearly related to the gas concentration, while the response kinetic constant of the desorption process is independent of the initial gas concentration. Therefore, according to equation (8), the intrinsic adsorption rate constant and the intrinsic desorption rate constant of metal oxides can be accurately measured.

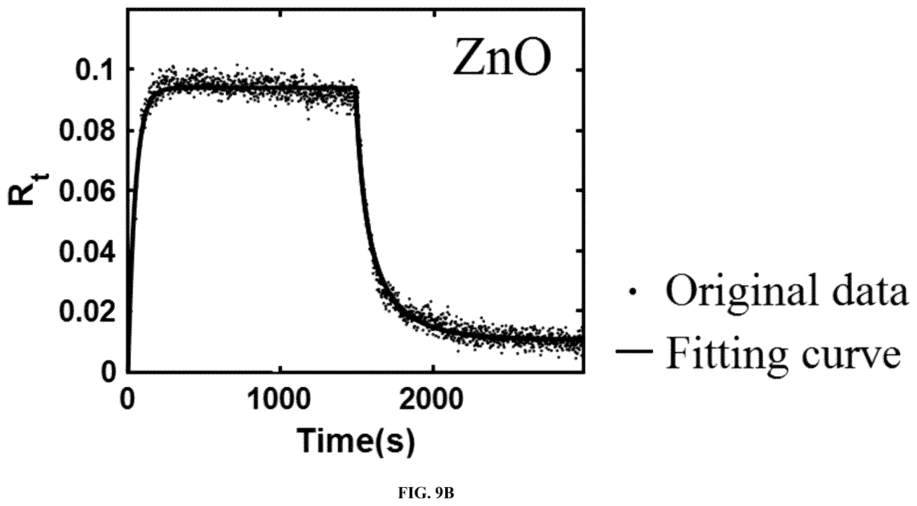

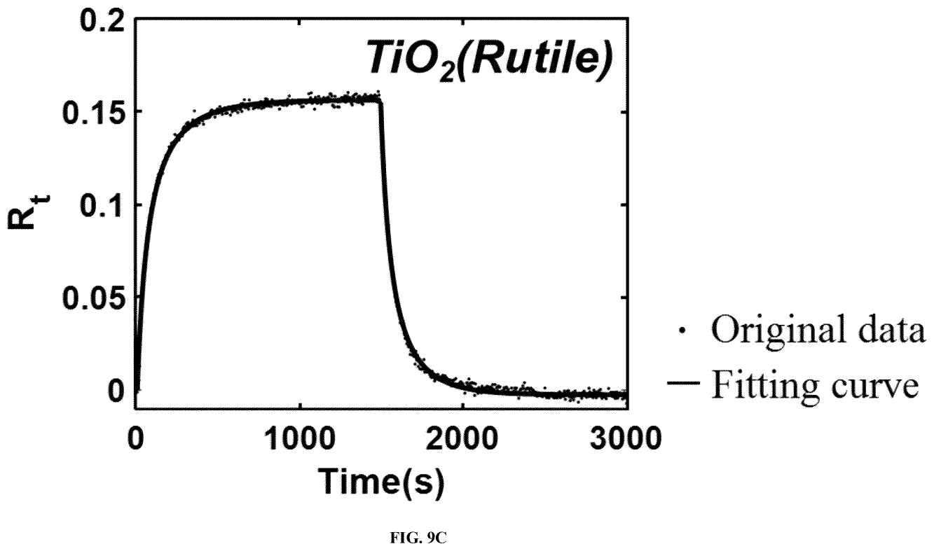

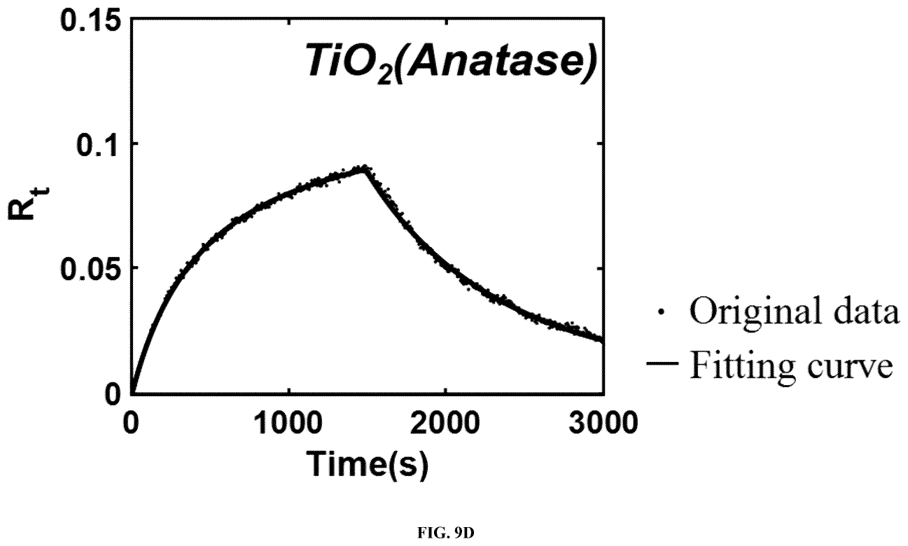

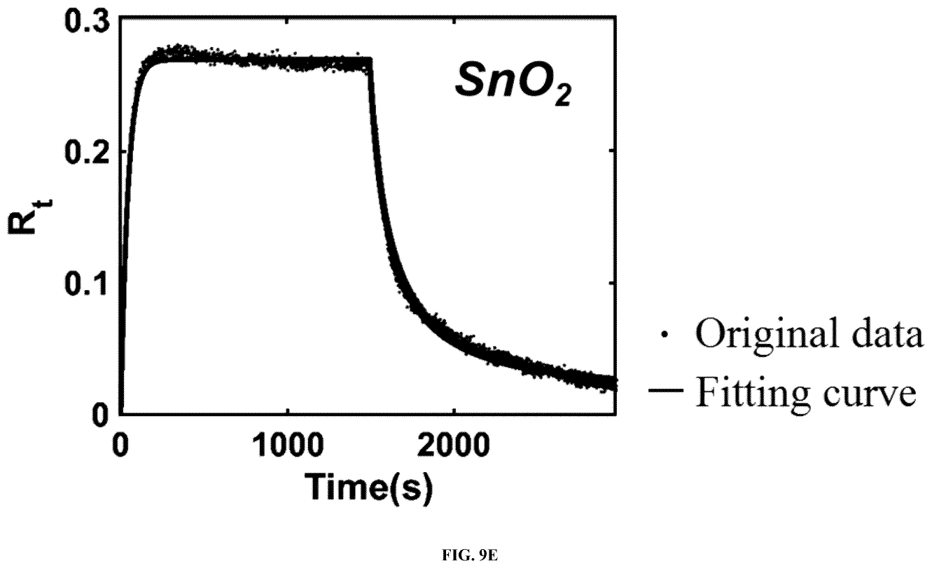

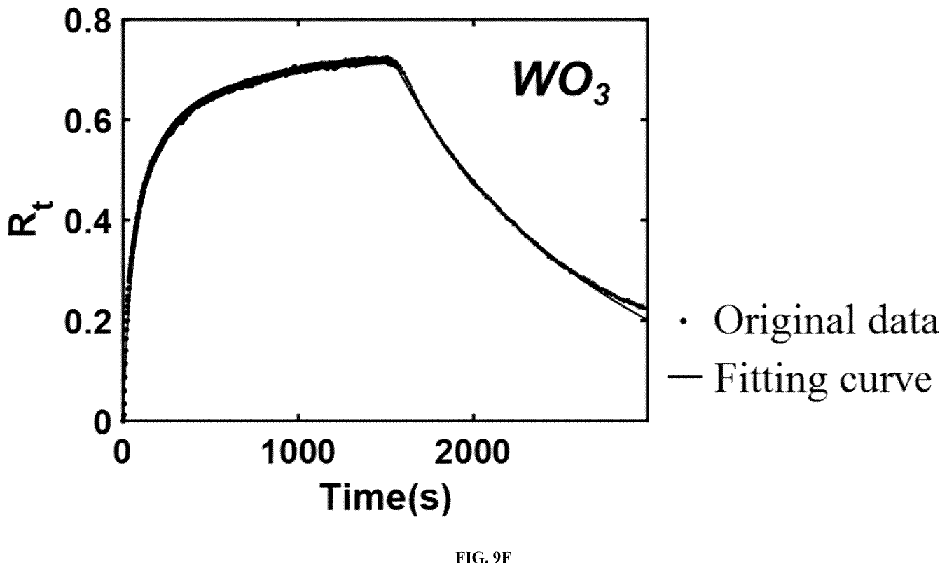

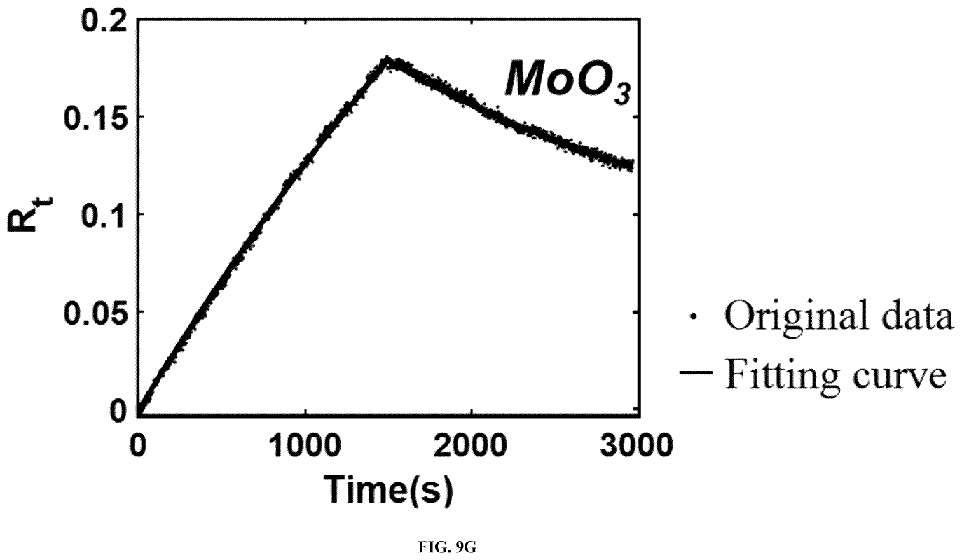

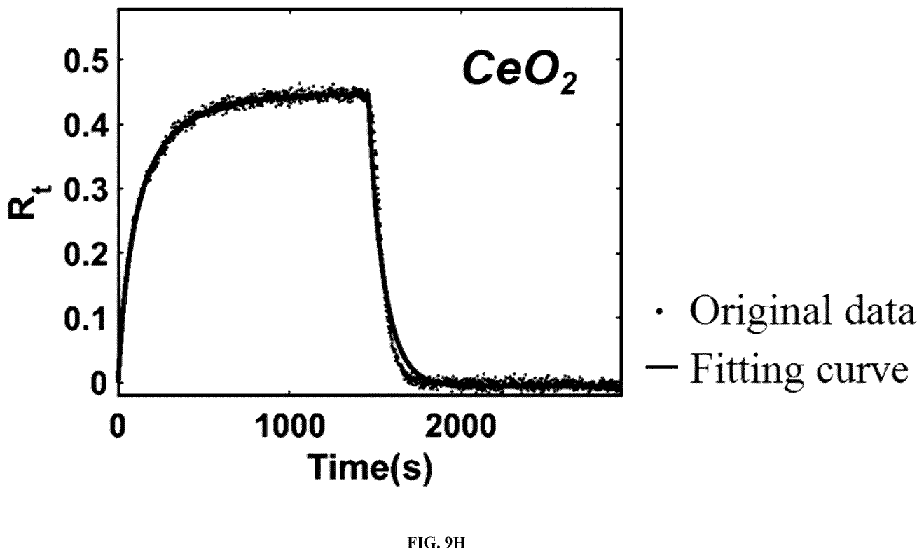

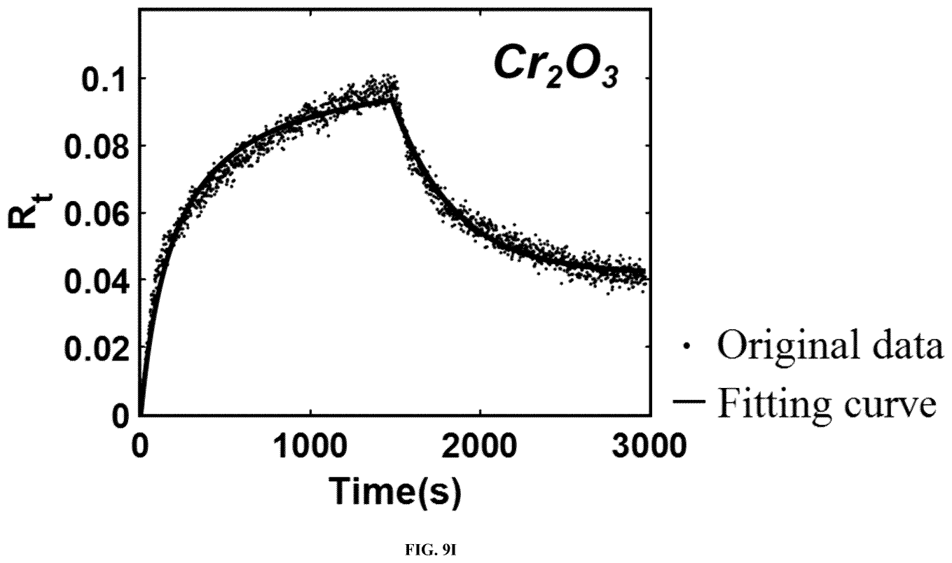

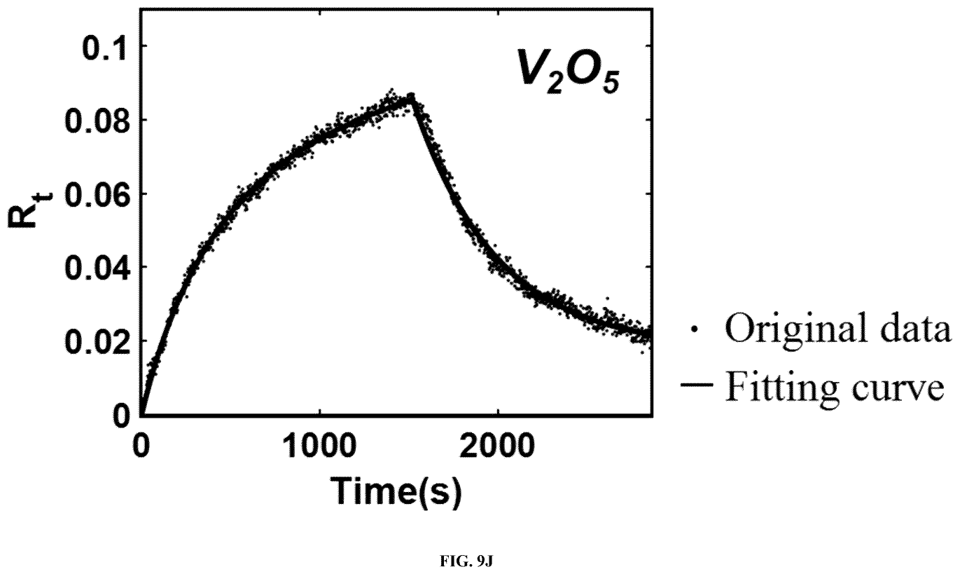

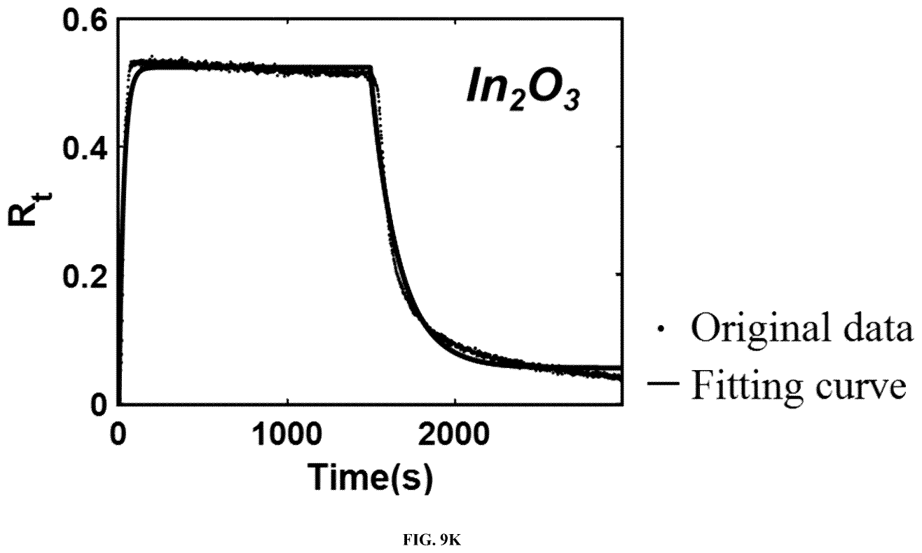

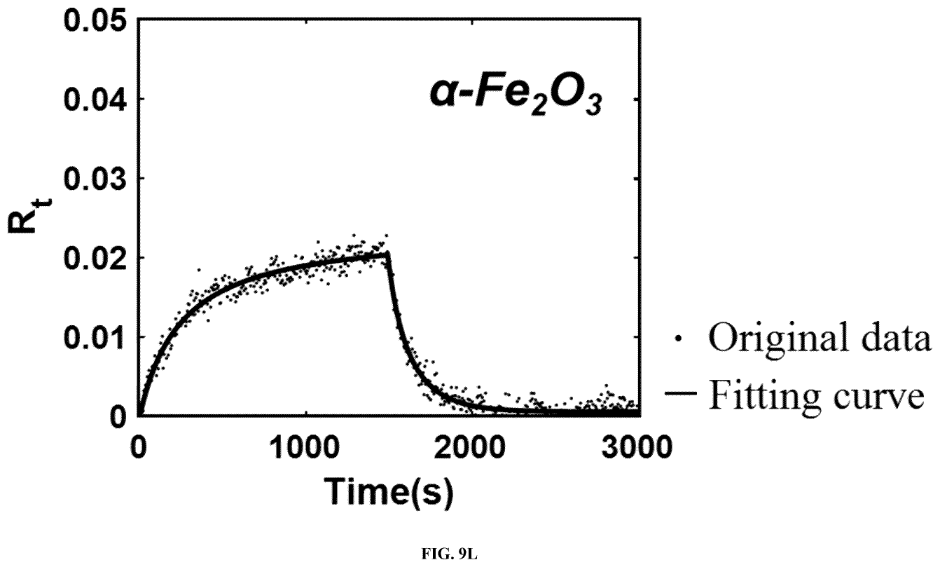

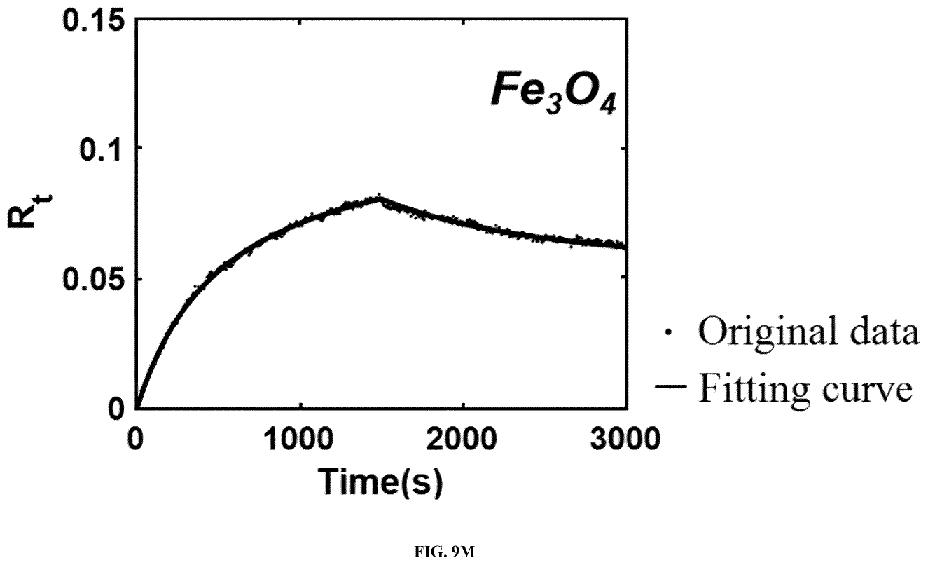

In an embodiment, infrared images in the process that gas molecules are adsorbed on and desorbed from the surfaces of a plurality of reaction samples are simultaneously recorded by a short-wave infrared camera. FIG. 9A shows infrared intensity change images of surfaces of a plurality of reaction samples according to an embodiment of the present disclosure. As shown in FIG. 9A, the infrared intensity change images are plurality of images according to the time sequence. FIGS. 9B-9M are schematic diagrams of kinetic curves and fitting curves of reaction samples in a metal oxide library substrate according to an embodiment of the present disclosure. Taking the reaction samples including WO₃, In₂O₃, SnO₂, Cr₂O₃, Fe₃O₄, TiO₂ (Anatase), CeO₂, ZnO, TiO₂ (Rutile), MoO₃, α-Fe₂O₃, and V₂O₅ as examples, the infrared response kinetic curves (the relation curves between the response value Rf of the infrared signal and the time) are extracted in batches by the data processing module, and data fitting is performed. The results are shown in FIGS. 9B-9M. The results of kinetic data of each reaction sample of the metal oxide library substrate measured in the experiment are shown in Table 2.

TABLE 2

| | | kₐ(kPa⁻¹s⁻¹) × | k_{d}(s⁻¹) × | K(kPa⁻¹) × |
|---|---|---|---|---|
| Sample | Q | 10⁻⁴ | 10⁻³ | 10⁻² |
| ZnO | 0 | 2.49 ± 0.15 | 5.81 ± 0.08 | 4.28 ± 0.21 |
| TiO₂ (Anatase) | 0.98 | 1.01 ± 0.01 | 1.33 ± 0.20 | 7.65 ± 1.18 |
| TiO₂ (Rutile) | 0.51 | 6.77 ± 0.44 | 17.8 ± 3.4 | 3.86 ± 0.49 |
| In₂O₃ | 0 | 29.3 ± 0.7 | 5.14 ± 0.65 | 57.6 ± 6.1 |
| SnO₂ | 0 | 14.3 ± 0.8 | 8.33 ± 0.44 | 17.1 ± 0.8 |
| WO₃ | 0.97 | 13.5 ± 0.5 | 1.05 ± 0.07 | 128.5 ± 3.2 |
| MoO₃ | 0 | 0.114 ± 0.007 | 0.404 ± 0.050 | 2.85 ± 0.35 |
| CeO₂ | 0.69 | 5.40 ± 0.43 | 9.17 ± 1.05 | 5.91 ± 0.29 |
| Cr₂O₃ | 0.99 | 8.62 ± 0.19 | 5.49 ± 0.31 | 15.7 ± 0.6 |
| V₂O₅ | 0.92 | 0.327 ± 0.036 | 2.01 ± 0.08 | 1.63 ± 0.14 |
| α-Fe₂O₃ | 0.93 | 2.00 ± 0.04 | 9.29 ± 0.14 | 2.18 ± 0.31 |
| Fe₃O₄ | 0.89 | 0.883 ± 0.045 | 0.758 ± 0.044 | 11.7 ± 1.3 |

According to the kinetic measurement results, ZnO, SnO₂ and In₂O₃ show typical pseudo-first-order adsorption kinetic characteristics (Q approaches 0), while WO₃, MoO₃, Cr₂O₃ and V₂O₅ show typical pseudo-second-order adsorption kinetic characteristics (Q approaches 1). The adsorption kinetic measurement results for the surface of rutile powder show that the adsorption characteristics do not follow the pure pseudo-first-order model and pseudo-second-order model. About 30% of contribution of the kinetic model comes from the pseudo-second-order model, and about 70% of contribution of the kinetic model comes from the pseudo-first-order model, which shows that there are carbonate intermediates with a plurality of adsorption modes. The proportion of monodentate carbonate intermediates is larger than that of bidentate carbonate intermediates. Another example is that the proportion of contribution of the pseudo-second-order model is more important than that of contribution of the pseudo-first-order model in the adsorption mode of the CeO₂ powder surface, which shows that the proportion of bidentate carbonate intermediates is greater than that of monodentate carbonate intermediates.

The equilibrium adsorption intensity constant K reflects the adsorption intensity of carbonate intermediates generated on the metal oxide surface at this temperature (300° C.). According to the measurement results, the adsorption intensity of carbonate intermediates generated on different metal oxide surfaces is in the following order: WO₃>In₂O₃>SnO₂>Cr₂O₃>Fe₃O₄>TiO₂ (Anatase)>CeO₂>ZnO>TiO₂ (Rutile)>MoO₃>α-Fe₂O₃>V₂O₅.

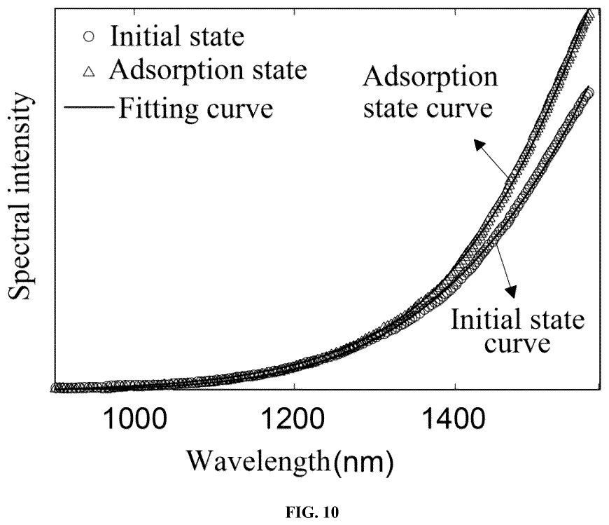

FIG. 10 is a diagram of a near-infrared spectrum and a spectrum fitting curve of carbon monoxide before and after adsorption on a surface of zinc oxide according to an embodiment of the present disclosure. The state prior to adsorption is referred to as the initial state. As shown in FIG. 10, it is experimentally observed that the signal intensity of the material surface captured by infrared imaging changes obviously in the initial state and the adsorption state. By comparing the near-infrared spectra of CO gas molecules before and after adsorption, it is found that there is no obvious characteristic peak of a carbonate intermediate after the combination of CO and oxygen adsorbed on the metal oxide surface, but the overall infrared spectrum shifts. The optical signal intensity I_{λ, T} recorded by the infrared imaging system has the following relationship with the infrared amplitude E_{λ, T} of the material surface:

$${I}_{λ , T} = {AE}_{λ , T} , \qquad ( 10 )$$

where A is a parameter related to the infrared imaging system.

FIG. 11A is an evolution spectrum of a near-infrared spectrum in a cycle of adsorption and desorption of carbon monoxide on and from a surface of zinc oxide according to an embodiment of the present disclosure. In an embodiment, a diagram of the infrared optical intensity curve of carbon monoxide on the surface of ZnO powder in the adsorption-desorption process is recorded. Further, after carbon monoxide adsorption on the ZnO powder surface reaches saturation, the evolution of the near-infrared spectrum in the desorption process by introducing N₂ is recorded, as shown in FIG. 11A.

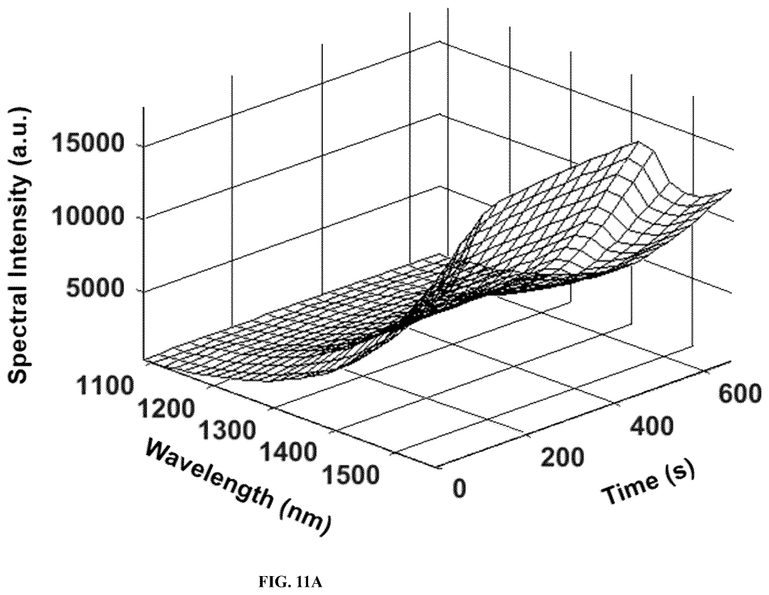

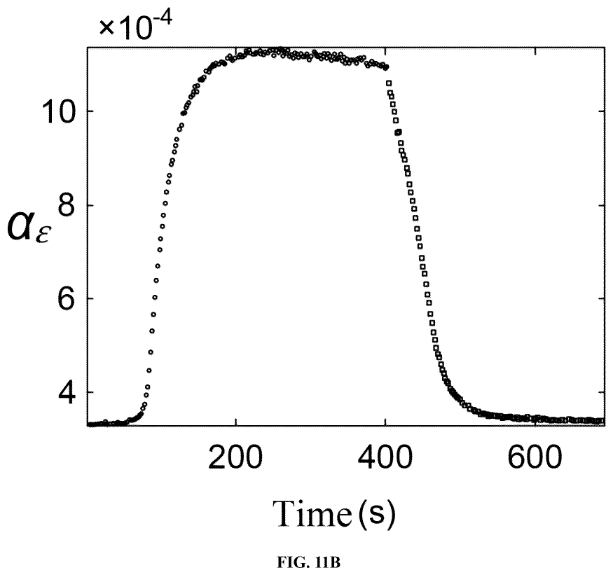

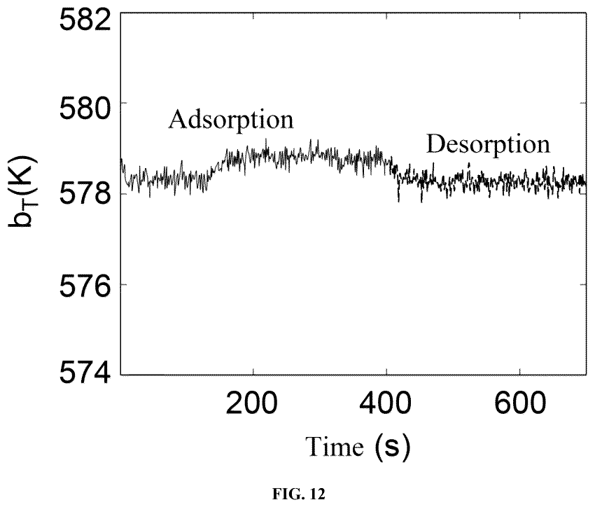

The emission spectral intensity of the material surface has the following relationship with the material emissivity:

$${I}_{λ , T} = A ε \frac{{c}_{1}}{{λ}^{5}} \frac{1}{{e}^{\frac{{c}_{2}}{λ T}} - 1} = {a}_{ε} \frac{{c}_{1}}{{λ}^{5}} \frac{1}{{e}^{\frac{{c}_{2}}{λ {b}_{T}}} - 1} , \qquad ( 11 )$$

where a_{ε} and b_{T} are parameters related to the surface emissivity and the surface temperature of materials, respectively, C₁ and C₂ are constants, λ is a wavelength, and T is the absolute temperature. The application form of Planck's blackbody radiation law in practical materials is equation (11), which is the predetermined Planck blackbody radiation equation. The near-infrared spectral data recorded at different wavelengths is fit. The initial state and the adsorption state are shown in FIG. 10. FIG. 11B is a diagram of an evolution kinetic curve of a surface infrared emissivity a_{ε} in a cycle of adsorption and desorption of carbon monoxide on and from a surface of zinc oxide according to an embodiment of the present disclosure. The emissivity a_{ε} of the ZnO surface at a specific moment is extracted from the fitting results, and the kinetic curve of the emissivity change of the metal oxide in the adsorption-desorption process is obtained, as shown in FIG. 11B. The adsorption process is 0 s to 400 s, and the desorption process is 400 s to 600 s. In addition, FIG. 12 is a diagram of a kinetic curve of a surface temperature change in a cycle of adsorption and desorption of carbon monoxide on and from a surface of zinc oxide. The curve of the parameter b_{T} (in unit of K) related to the temperature of the material surface in the adsorption-desorption process is shown in FIG. 12, in which the adsorption process is 0 s to 400 s, and the desorption process is 400 s to 600 s. The characteristics of the temperature kinetic curve show that the temperature fluctuation is small in the adsorption-desorption process, which may be regarded as a thermal equilibrium process. FIG. 13 is a diagram of the correlation between a surface emissivity and a surface radiation infrared signal intensity in a cycle of absorption and desorption of carbon monoxide on and from a surface of zinc oxide according to an embodiment of the present disclosure. The original data and the linear fitting curve of the infrared optical intensity and the emissivity a_{ε} are shown in FIG. 13. The optical intensity of short-wave infrared imaging is equivalent to the integral of the near-infrared spectral intensity. Therefore, the infrared optical intensity and the emissivity a_{ε} change linearly in the adsorption state, which indicates that the infrared imaging technology has the ability of high-throughput kinetic measurement.

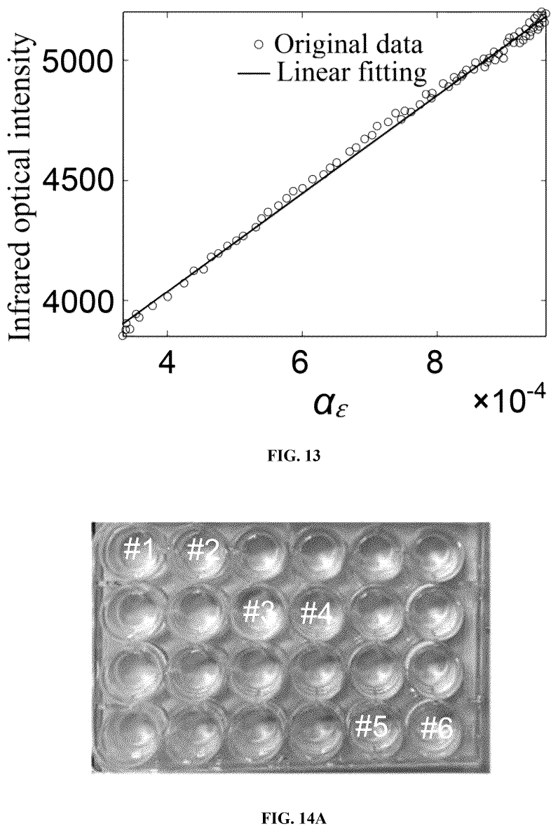

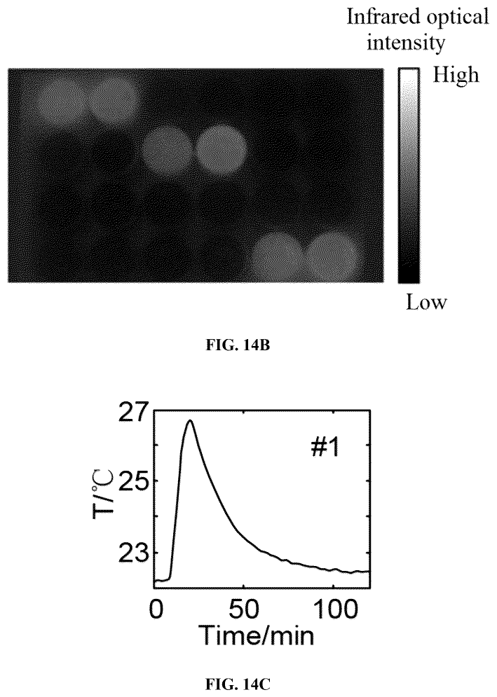

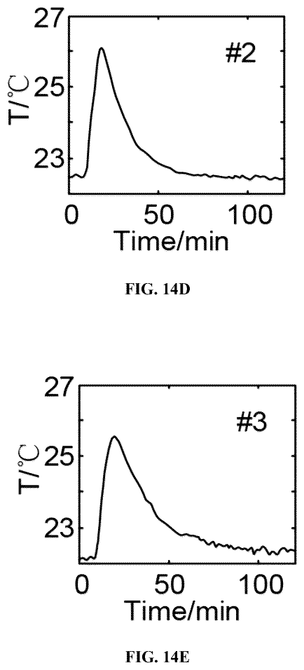

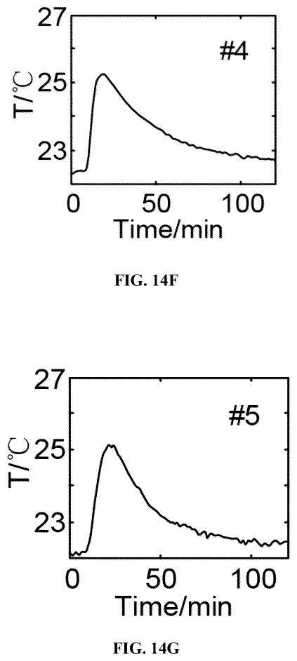

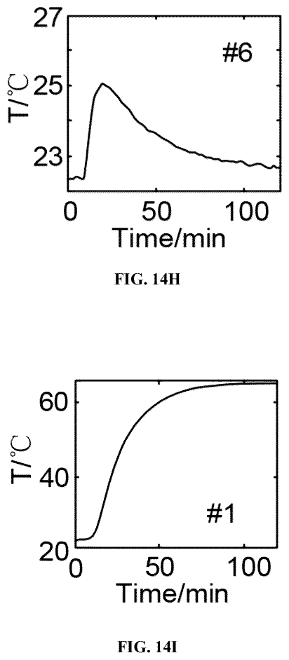

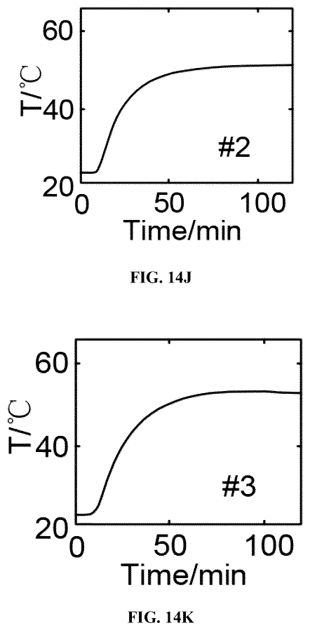

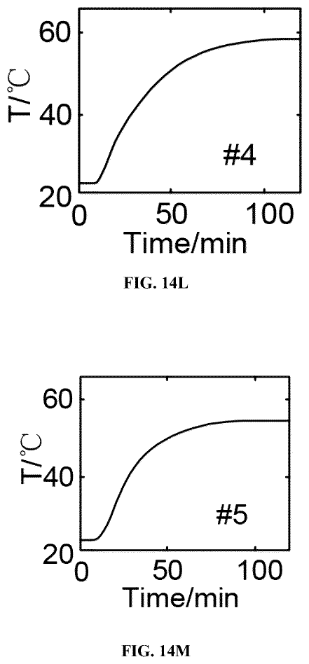

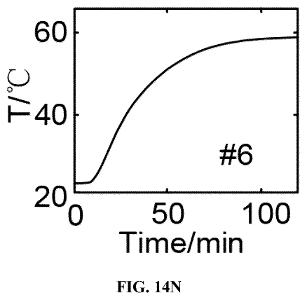

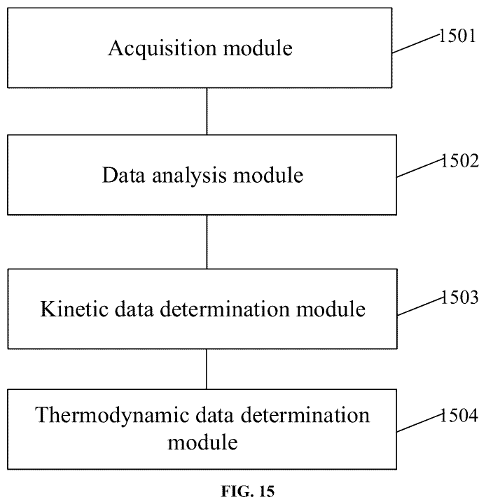

FIG. 14A is a bright-field image of organic amine alkaline solution sample libraries with different concentration ratios according to an embodiment of the present disclosure. In an embodiment, in the thermal temperature kinetic research of gas-liquid interface adsorption, the infrared imaging system uses a resin orifice plate with a lower infrared emissivity to fill CO₂ to adsorb organic amine alkaline solution, as shown in FIG. 14A. Take #1, #2, #3, #4, #5, and #6 in FIG. 14A as an example.

FIG. 14B is an infrared image of organic amine alkaline solution sample libraries with different concentration ratios according to an embodiment of the present disclosure. The infrared camera may directly perform infrared imaging on the temperature data of each organic amine alkaline solutions with different concentration ratios in the metal oxide library substrate. The infrared images of the organic amine alkaline solution sample libraries with different concentration ratios is shown in FIG. 14B, in which the infrared optical intensity, ranging from low to high, is displayed with colors transitioning from dark to light in the infrared image. The exothermic kinetic measurement of the reaction between CO₂ gas molecules and organic amine alkaline solution is taken as a specific case. When the reaction gas carbon dioxide is introduced into the in-situ gas flow cell, the temperature rises due to the reaction of CO₂ gas molecules with the surface of organic amine alkaline solution and the release of heat, which leads to the response of the surface infrared intensity. FIGS. 14C-14H are diagrams of kinetic curves characterizing a temperature change of carbon dioxide molecules and organic amine alkaline solutions with different concentrations in an adsorption process according to an embodiment of the present disclosure. The infrared response characteristics of the alkaline solution surface may be recorded in real time by an infrared camera. The infrared thermal imaging temperature response curves of the alkali solution surfaces of #1, #2, #3, #4, #5, and #6 are shown in FIGS. 14C-14H. The specific experimental operation steps are as follows.

Step 1), the organic amine alkaline solutions with different concentration ratios are packaged in the in-situ gas flow cell.

Step 2), the mass flowmeter is turned on and the nitrogen atmosphere is introduced at a specific flow rate to purge the in-situ gas flow cell until the in-situ gas flow cell is kept in a pure nitrogen inert atmosphere.

Step 3), the sample to be measured is kept at the reaction temperature, the infrared camera is turned on to start shooting in a delay manner with a specific shooting frequency, and the intensity of the infrared image recorded at this time is taken as the intensity baseline.

Step 4), in the gas reaction process, the inert atmosphere in the in-situ gas flow cell is switched to a CO₂ gas atmosphere with a specific concentration, carbon dioxide gas molecules start to be adsorbed on the surface of alkaline solution to react and release heat to start heating up, the infrared signal intensity starts to respond with time, and the intensity curve of this recorded infrared image is the kinetic curve of temperature rise in the reaction process.

Step 5), in a reaction ending process, as the reaction continues, the alkaline solution is gradually consumed, and the reaction rate decreases, the released heat is less than the heat dissipated by the system into the air, and the temperature of the system starts to decrease and then returns to the baseline stage after the reaction is completely ended, which is a complete reaction process.

In step 6), recording the cooling process of the solution: the liquid with a specific temperature higher than the room temperature is dropped into the in-situ gas flow cell outside the process of Step 4 to Step 5, and the infrared camera is turned on to record the change of the infrared signal in the temperature decreasing process.

In step 7), the temperature is fitted with the temperature decreasing rate in Step 6 to obtain a temperature reducing rate resulted from heat dissipation at different temperatures.

In step 8), based on the kinetic curves obtained in Step 4 to Step 5 and taking the temperature dissipation obtained in Step 7 as the processing condition, the temperature data in the reaction is analyzed to obtain the temperature rise of the ideal adiabatic system without heat dissipation.

FIGS. 14I-14N are diagrams of temperature rise processes of an ideal adiabatic system of carbon dioxide molecules and organic amine alkaline solutions with different concentrations in a reaction process after kinetic fitting in the adsorption process according to an embodiment of the present disclosure. In an embodiment, the temperature decreasing curve obtained in the above process with respect to the time change is derived, and then the obtained temperature decreasing rate value is used to fit the temperature value. The temperature change curves of the simulated adiabatic system of the organic amine alkali solution surfaces of #1, #2, #3, #4, #5, and #6 are shown in FIGS. 14I-14N. The thermal dissipation coefficient of delivering the temperature of the corresponding organic amine alkali solution to the environment within this temperature range is obtained. The fitting equation used in the fitting process is:

$$\frac{dT}{dt} = \frac{{h}_{1}}{{M}_{r} c} ( T - {T}_{0} ) + \frac{{h}_{2}}{{M}_{r} c} ( {T}^{4} - {T}_{0}^{4} ) , \qquad ( 12 )$$

where c is the specific heat capacity in the system in unit of J·g⁻¹·K⁻¹; Mᵣ is the mass fraction of the organic amine alkaline solution reacted in the solution in unit of g; h₁ is the coefficient represented by the heat dissipation process resulted from heat transfer and convection of organic amine alkaline solution to the surrounding area in unit of J·(K·s)⁻¹; h₂ is the coefficient represented by the heat dissipation process resulted from thermal radiation of alkali solution to the surrounding area in unit of J·(K⁴·s)⁻¹; T is the real-time temperature; T₀ is the ambient temperature around the solution in unit of ° C.; and t is the time in unit of s. The equation (12) is the thermal dissipation kinetic equation.

After the heat dissipation equation is obtained, the kinetic curve characterizing the temperature change is processed. For each temperature value at each moment, the temperatures that decreases due to thermal dissipation at all preceding moments are accumulated to obtain the theoretical temperature change of the system under the simulated adiabatic system.

By simulating the temperature rise value obtained due to the complete reaction in the adiabatic system, in combination with the heat capacity value of the system and the known solution properties, the reaction heat in the solution reaction process may be calculated. The calculation equation is as follows:

$$Δ H = \frac{Δ {TM}_{r} c}{V} , \qquad ( 13 )$$

where c is the specific heat capacity in the system in unit of J·g⁻¹·K⁻¹; Mᵣ is the mass fraction of the organic amine alkaline solution reacted in the solution in unit of g; ΔT is the final temperature rise in the simulated adiabatic system which is obtained by calculation in unit of K; V is the volume of the organic amine alkaline solution added in the in-situ reaction cell in unit of ml; and ΔH is the reaction heat of organic amine alkaline solution in unit of kJ/ml.

The measured absorption reaction heat values of different alkali solution CO₂ are shown in Table 3 below.

TABLE 3

| | Heat | | | | |
|---|---|---|---|---|---|
| | capacity | h1 | h2 | Temperature | Reaction |
| | value | (J(K · | (J(K⁴ · | difference | heat |
| Sample | (J/K) | s)⁻¹) | s)⁻¹) | (K) | (J/ml) |
| 1# | 0.7539 | 3.6 × 10⁻³ | 4.45 × 10⁻⁸ | 41.8 | 326.8 |
| 2# | 0.7690 | 3.9 × 10⁻³ | 3.67 × 10⁻⁸ | 27.9 | 218.2 |
| 3# | 0.7420 | 3.7 × 10⁻³ | 4.28 × 10⁻⁸ | 29.9 | 232.7 |
| 4# | 0.7419 | 4.7 × 10⁻³ | 2.92 × 10⁻⁸ | 35.1 | 273.3 |
| 5# | 0.7542 | 4.8 × 10⁻³ | 2.92 × 10⁻⁸ | 31.3 | 245.4 |
| 6# | 0.7533 | 5.5 × 10⁻³ | 2.03 × 10⁻⁸ | 35.5 | 278.2 |

The embodiment of the present disclosure further provides a detection apparatus based on an infrared imaging system, as described in the following embodiment. Because the principle that the apparatus solves the problem is similar to the detection method based on the infrared imaging system, the implementation of the apparatus can refer to the implementation of the detection method based on the infrared imaging system, and the repetition is not described in detail here.

FIG. 15 is a structural block diagram of a detection apparatus based on an infrared imaging system according to an embodiment of the present disclosure. As shown in FIG. 15, the detection apparatus based on the infrared imaging system includes the foregoing infrared imaging system, and further includes:
an acquisition module 1501, configured to acquire infrared images of a surface of a reaction sample; where the reaction sample includes a solid sample or a gas sample;
a data analysis module 1502, configured to perform data analysis on the infrared images and extract a kinetic curve from the infrared images;
a kinetic data determination module 1503, configured to, when the reaction sample is a solid sample, fit the kinetic curve by using a predetermined adsorption kinetic equation to determine kinetic data of the surface of the reaction sample, and/or fit the kinetic curve by using a thermal dissipation kinetic equation to determine thermodynamic data of the surface of the reaction sample; where the kinetic curve is an infrared image intensity curve; and
a thermodynamic data determination module 1504, configured to, when the reaction sample is a liquid sample, fit the kinetic curve by using the thermal dissipation kinetic equation to determine the thermodynamic data of the surface of the reaction sample.

In an embodiment, the detection apparatus based on the infrared imaging system may further include an image parsing module, which is configured to:
parse the infrared image into an infrared spectrogram; and
perform data fitting on the infrared spectrogram by using a predetermined Planck blackbody radiation equation, and determine emissivity change characteristics and temperature change characteristics of the surface of the reaction sample; where the predetermined Planck blackbody radiation equation is determined by a Planck's blackbody radiation law.

In an embodiment, the data analysis module 1502 is specifically configured to:
extract the kinetic curve of the surface of the reaction sample in the infrared images according to the time sequence; where the kinetic curve includes an adsorption kinetic curve and a desorption kinetic curve; the adsorption kinetic curve is an infrared image intensity curve in a process of adsorbing the reaction gas on the surface of the reaction sample; and the desorption kinetic curve is an infrared image intensity curve in a process of desorbing the reaction gas on the surface of the reaction sample;
when the reaction sample is a solid sample, fitting the kinetic curve by using a predetermined adsorption kinetic equation to determine kinetic data of the surface of the reaction sample includes:
fitting the kinetic curve by using the predetermined adsorption kinetic equation to determine a kinetic rate constant of the adsorption process and a kinetic rate constant of the desorption process; where the predetermined adsorption kinetic equation is determined by a Langmuir adsorption law; and determining an equilibrium constant of gas-solid interface reaction according to the kinetic rate constant of the adsorption process and the kinetic rate constant of the desorption process.

In an embodiment, the predetermined adsorption kinetic equation is:

$$\begin{matrix}{R}_{t} = {a}_{0} \frac{1 - exp ( - {k}_{L} t )}{1 - Q exp ( - {k}_{L} t )} ( {a}_{0} = {θ}_{e} \frac{Δ {ε}_{m}}{{ε}_{0}} ) ; \\ {k}_{L} = ( 1 - Q ) \frac{{k}_{a} {p}_{i}}{{θ}_{e}} ;\end{matrix}$$

where Rₜ is a response value of an infrared signal; Q reflects a weight contributed by a pseudo-first-order kinetic model and a pseudo-second-order kinetic model, when the value of Q approaches 0, the adsorption kinetic characteristics show pseudo-first-order kinetic characteristics, and when the value of Q approaches 1, the adsorption kinetic characteristics show pseudo-second-order kinetic characteristics; t is the time; kₐ is an intrinsic adsorption kinetic constant; pᵢ is a partial pressure of adsorbate gas; θ_{ε} is an equilibrium adsorption coverage; Δεₘ is a change value of infrared emissivity when the surface of the reaction sample reaches the maximum adsorption state; and ε₀ is the initial infrared emissivity of a site on the surface of the reaction sample.

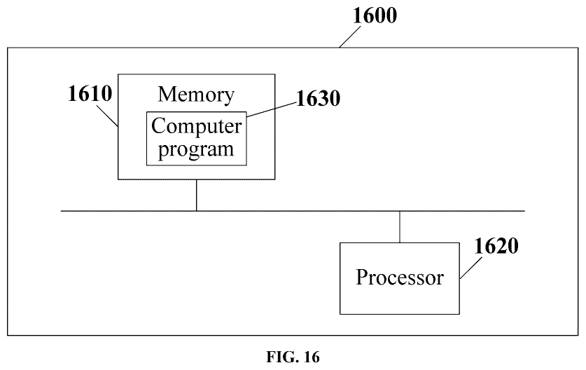

Based on the foregoing inventive concept, as shown in FIG. 16, the present disclosure further provides a computer device 1600, including a memory 1610, a processor 1620 and a computer program 1630 stored in the memory 1610 and executable on the processor 1620. The processor 1620, when executing the computer program 1630, implements the detection method based on the infrared imaging system.

Based on the foregoing inventive concept, the present disclosure provides a computer-readable storage medium. A computer program is stored in the computer-readable storage medium, and the computer program, when executed by a processor, implements the detection method based on the infrared imaging system.

Based on the foregoing inventive concept, the present disclosure provides a computer program product. The computer program product includes a computer program, and the computer program, when executed by a processor, implements the detection method based on the infrared imaging system.

The embodiment of the present disclosure provides a method of implementing in-situ high-throughput reaction kinetic measurement of gas molecules on the surface of transition metal oxides by using the infrared imaging technology. Fitting of the Langmuir adsorption kinetic model can distinguish the adsorption modes of gas molecules on different metal oxide surfaces and quantitatively measure the binding kinetics, the dissociation kinetics and reaction equilibrium constants between oxygen adsorbed on surfaces of different metal oxides and gas molecules. This technology not only provides a new way to efficiently monitor the evolution kinetics of oxygen adsorbed on surfaces of metal oxides, but also brings a new perspective for the research in the fields of catalysis and sensing.

The embodiment of the present disclosure provides a method of implementing in-situ high-throughput reaction thermal analysis of organic amine alkaline solution and CO₂ by the using infrared imaging technology. Data analysis is performed by the thermal dissipation kinetic model, and the difference of reaction enthalpy between different alkaline solution formulations is further calculated. This technology is expected to be used as a high-throughput strategy to screen out a high-performance CO₂ absorbent from a large number of potential excellent absorbent formulations.

It should be understood by those skilled in the art that the embodiment of the present disclosure may be provided as a method, a system, or a computer program product. Therefore, the present disclosure can take the form of an entirely hardware embodiment, an entirely software embodiment, or an embodiment combining software and hardware. Furthermore, the present disclosure can take the form of a computer program product embodied on one or more computer-usable storage media (including but not limited to a disk storage, a CD-ROM, an optical storage, etc.) containing a computer-usable program code therein.

The present disclosure is described with reference to a flowchart and/or a block diagram of a method, a device (a system), and a computer program product according to the embodiment of the present disclosure. It should be understood that each flow and/or block in the flowchart and/or block diagram, and a combination of the flows and/or blocks in the flowchart and/or the block diagram may be implemented by a computer program instruction. These computer program instructions may be provided to a processor of a general-purpose computer, a special-purpose computer, an embedded processor or other programmable data processing devices to produce a machine, such that the instructions which are executed by the processor of the computer or other programmable data processing devices produce an apparatus for implementing the functions specified in one or more flows in the flowchart and/or one or more blocks in the block diagram.

These computer program instructions may also be stored in a computer-readable memory that can direct a computer or other programmable data processing devices to work in a particular manner, such that the instructions stored in the computer-readable memory produce an article of manufacture including an instruction apparatus, and the instruction apparatus implements the functions specified in one or more flows in the flowchart and/or one or more blocks in the block diagram.

These computer program instructions may also be loaded onto a computer or other programmable data processing devices, such that a series of operational steps are performed on the computer or other programmable devices to produce a computer-implemented process, such that the instructions executed on the computer or other programmable devices provide steps for implementing the functions specified in one or more flows in the flowchart and/or one or more blocks in the block diagram.

The specific embodiments described above further explain the objective, the technical solution and beneficial effects of the present disclosure in detail. It should be understood that the above are only specific embodiments of the present disclosure and are not used to limit the scope of protection of the present disclosure. Any modification, equivalent substitution, improvement, and the like made within the spirit and principle of the present disclosure should be included in the scope of protection of the present disclosure.

1. An infrared imaging system, comprising: an in-situ reaction cell module, an infrared optical imaging module, and a data processing module; wherein:
the in-situ reaction cell module comprises an in-situ gas flow cell, a mass flowmeter and a gas source; the in-situ gas flow cell comprises a gas flow cavity, a heating stage, and a metal oxide library substrate arranged in the gas flow cavity and placed on the heating stage; the metal oxide library substrate is provided with a plurality of holes into which reaction samples are placed; the reaction sample comprises a solid sample or a liquid sample; the gas source is configured to deliver reaction gas into the gas flow cavity of the in-situ gas flow cell through the mass flowmeter; the mass flowmeter is configured to control a concentration and a flow rate of the reaction gas; and the heating stage is configured to heat the reaction sample;
the infrared optical imaging module is configured to acquire infrared images of a surface of the reaction sample and send the infrared images to the data processing module;
the data processing module is configured to perform data analysis on the infrared images received and extract a kinetic curve from the infrared images;
in a case that the reaction sample is the solid sample, the data processing module is further configured to fit the kinetic curve by using a predetermined adsorption kinetic equation to determine kinetic data of the surface of the reaction sample, and/or fit the kinetic curve by using a thermal dissipation kinetic equation to determine thermodynamic data of the surface of the reaction sample; wherein the kinetic curve is an infrared image intensity curve; and
in a case that the reaction sample is a liquid sample, the data processing module is further configured to fit the kinetic curve by using a thermal dissipation kinetic equation to determine thermodynamic data of the surface of the reaction sample.

2. The infrared imaging system according to claim 1, wherein the in-situ gas flow cell further comprises an infrared optical window; the infrared optical window is configured to allow an infrared ray emitted from the surface of the reaction sample to exit the in-situ gas flow cell; the infrared optical window is made of a material with a transmittance in a short-wave infrared region greater than a predetermined transmittance; and the metal oxide library substrate is located directly below the infrared optical window.

3. The infrared imaging system according to claim 1, wherein the gas flow cavity is provided with a gas inlet and a gas outlet; wherein the gas source is delivered to the gas flow cavity through the mass flowmeter and the gas inlet in sequence; the gas outlet is connected with a tail gas treatment module; the tail gas treatment module is configured to store and process acquired gas; and the in-situ gas flow cell is configured to provide a reaction channel for the reaction gas and the reaction sample.

4. The infrared imaging system according to claim 1, wherein the infrared optical imaging module comprises a short-wave infrared camera; a photosensitive band of the short-wave infrared camera ranges from 0.9 microns to 1.7 microns; and the short-wave infrared camera is configured to acquire the infrared images of the surface of the reaction sample without introducing an additional light source.

5. The infrared imaging system according to claim 4, wherein the infrared optical imaging module further comprises a short-wave infrared spectrometer and an infrared optical lens; and an imaging band of the short-wave infrared spectrometer is matched with the short-wave infrared camera;
the infrared optical lens is configured to acquire an infrared ray emitted from the surface of the reaction sample; and
the short-wave infrared spectrometer is configured to generate the infrared images according to the infrared ray acquired by the infrared optical lens and project the infrared images to the short-wave infrared camera.

6. The infrared imaging system according to claim 5, wherein the data processing module is further configured to:
parse the infrared images collected by the infrared spectrometer and projected on the infrared camera into an infrared spectrogram; and
perform data fitting on the infrared spectrogram by using a predetermined Planck blackbody radiation equation, and determine emissivity change characteristics and temperature change characteristics of the surface of the reaction sample; wherein the predetermined Planck blackbody radiation equation is determined by a Planck's blackbody radiation law.

7. The infrared imaging system according to claim 1, wherein the infrared optical imaging module is configured to shoot in a delayed manner according to a predetermined frame rate to acquire the infrared images, wherein the infrared images are an image sequence; and the infrared images are sent to the data processing module according to a time sequence.

8. The infrared imaging system according to claim 7, wherein in the case that the reaction sample is the solid sample, the data processing module is configured to:
extract the kinetic curve of the surface of the reaction sample in the infrared images according to the time sequence; wherein the kinetic curve comprises an adsorption kinetic curve and a desorption kinetic curve; the adsorption kinetic curve is an infrared image intensity curve in an adsorption process of the reaction gas on the surface of the reaction sample; and the desorption kinetic curve is an infrared image intensity curve in a desorption process of the reaction gas from the surface of the reaction sample;
fit the kinetic curve by using the predetermined adsorption kinetic equation to determine a kinetic rate constant of the adsorption process and a kinetic rate constant of the desorption process; wherein the predetermined adsorption kinetic equation is determined by a Langmuir adsorption law; and
determine an equilibrium constant of gas-solid interface reaction according to the kinetic rate constant of the adsorption process and the kinetic rate constant of the desorption process.

9. The infrared imaging system according to claim 8, wherein the predetermined adsorption kinetic equation is:
$$\begin{matrix}{R}_{t} = {a}_{0} \frac{1 - exp ( - {k}_{L} t )}{1 - Q exp ( - {k}_{L} t )} ( {a}_{0} = {θ}_{e} \frac{Δ {ε}_{m}}{{ε}_{0}} ) ; \\ {k}_{L} = ( 1 - Q ) \frac{{k}_{a} {p}_{i}}{{θ}_{e}} ;\end{matrix}$$
where Rₜ is a response value of an infrared signal; Q reflects a weight contributed by a pseudo-first-order kinetic model and a pseudo-second-order kinetic model, when a value of Q approaches 0, adsorption kinetic characteristics show pseudo-first-order kinetic characteristics, and when the value of Q approaches 1, the adsorption kinetic characteristics show pseudo-second-order kinetic characteristics; t is a time; kₐ is an intrinsic adsorption kinetic constant; pᵢ is a partial pressure of adsorbate gas; θₑ is an equilibrium adsorption coverage; Δεₘ is a change value of infrared emissivity when the surface of the reaction sample reaches a maximum adsorption state; and ε₀ is an initial infrared emissivity of a site on the surface of the reaction sample.

10. The infrared imaging system according to claim 1, wherein the metal oxide library substrate is inert to the reaction gas; an infrared emissivity of the metal oxide library substrate is lower than a predetermined infrared emissivity; and a thermal conductivity of the metal oxide library substrate is higher than a predetermined thermal conductivity.

11. The infrared imaging system according to claim 1, wherein the heating stage is made of brass with a thermal conductivity higher than a predetermined thermal conductivity; the heating stage comprises a ceramic heating rod and a thermocouple; and the ceramic heating rod and the thermocouple are configured to heat or cool the reaction sample in the metal oxide library substrate to a predetermined temperature or maintain a constant temperature.

12. A detection method based on an infrared imaging system, wherein the detection method is applied to the infrared imaging system according to claim 1, comprising:
acquiring the infrared images of the surface of the reaction sample; wherein the reaction sample comprises the solid sample or the liquid sample;
performing the data analysis on the infrared images and extracting the kinetic curve from the infrared images;
in the case that the reaction sample is the solid sample, fitting the kinetic curve by using the predetermined adsorption kinetic equation to determine the kinetic data of the surface of the reaction sample, and/or fitting the kinetic curve by using the thermal dissipation kinetic equation to determine the thermodynamic data of the surface of the reaction sample; wherein the kinetic curve is the infrared image intensity curve; and
in the case that the reaction sample is the liquid sample, fitting the kinetic curve by using the thermal dissipation kinetic equation to determine the thermodynamic data of the surface of the reaction sample.

13. The detection method based on the infrared imaging system according to claim 12, further comprising:
parsing the infrared image into an infrared spectrogram; and
performing data fitting on the infrared spectrogram by using a predetermined Planck blackbody radiation equation, and determining emissivity change characteristics and temperature change characteristics of the surface of the reaction sample; wherein the predetermined Planck blackbody radiation equation is determined by a Planck's blackbody radiation law.

14. The detection method based on the infrared imaging system according to claim 12, wherein the performing the data analysis on the infrared images and extracting the kinetic curve from the infrared images comprises:
extracting the kinetic curve of the surface of the reaction sample in the infrared images according to a time sequence; wherein the kinetic curve comprises an adsorption kinetic curve and a desorption kinetic curve; the adsorption kinetic curve is an infrared image intensity curve in an adsorption process of the reaction gas on the surface of the reaction sample; and the desorption kinetic curve is an infrared image intensity curve in a desorption process of the reaction gas from the surface of the reaction sample; and
wherein in the case that the reaction sample is the solid sample, fitting the kinetic curve by using the predetermined adsorption kinetic equation to determine the kinetic data of the surface of the reaction sample comprises:
fitting the kinetic curve by using the predetermined adsorption kinetic equation to determine a kinetic rate constant of the adsorption process and a kinetic rate constant of the desorption process; wherein the predetermined adsorption kinetic equation is determined by a Langmuir adsorption law; and determining an equilibrium constant of gas-solid interface reaction according to the kinetic rate constant of the adsorption process and the kinetic rate constant of the desorption process.

15. The detection method based on the infrared imaging system according to claim 14, wherein the predetermined adsorption kinetic equation is:
$$\begin{matrix}{R}_{t} = {a}_{0} \frac{1 - exp ( - {k}_{L} t )}{1 - Q exp ( - {k}_{L} t )} ( {a}_{0} = {θ}_{e} \frac{Δ {ε}_{m}}{{ε}_{0}} ) ; \\ {k}_{L} = ( 1 - Q ) \frac{{k}_{a} {p}_{i}}{{θ}_{e}} ;\end{matrix}$$
where Rₜ is a response value of an infrared signal; Q reflects a weight contributed by a pseudo-first-order kinetic model and a pseudo-second-order kinetic model, when a value of Q approaches 0, adsorption kinetic characteristics show pseudo-first-order kinetic characteristics, and when the value of Q approaches 1, the adsorption kinetic characteristics show pseudo-second-order kinetic characteristics; t is a time; kₐ is an intrinsic adsorption kinetic constant; pᵢ is a partial pressure of adsorbate gas; θₑ is an equilibrium adsorption coverage; Δεₘ is a change value of infrared emissivity when the surface of the reaction sample reaches a maximum adsorption state; and ε₀ is an initial infrared emissivity of a site on the surface of the reaction sample.

16. A detection apparatus based on an infrared imaging system, comprising the infrared imaging system according to claim 1, and further comprising:
an acquisition module, configured to acquire the infrared images of the surface of the reaction sample; wherein the reaction sample comprises the solid sample or the liquid sample;
a data analysis module, configured to perform the data analysis on the infrared images and extract the kinetic curve from the infrared images;
a kinetic data determination module, configured to, in the case that the reaction sample is the solid sample, fit the kinetic curve by using the predetermined adsorption kinetic equation to determine the kinetic data of the surface of the reaction sample, and/or fit the kinetic curve by using the thermal dissipation kinetic equation to determine the thermodynamic data of the surface of the reaction sample; wherein the kinetic curve is the infrared image intensity curve; and
a thermodynamic data determination module, configured to, in the case that the reaction sample is the liquid sample, fit the kinetic curve by using the thermal dissipation kinetic equation to determine the thermodynamic data of the surface of the reaction sample.

17. A computer device, comprising: a memory, a processor and a computer program stored in the memory and executable on the processor, wherein the processor, when executing the computer program, implements the method according to claim 12.

18. A computer-readable storage medium, having a computer program stored thereon, wherein the computer program, when executed by a processor, implements the method according to claim 12.

19. The computer-readable storage medium according to claim 18, the method further comprising:
parsing the infrared image into an infrared spectrogram; and
performing data fitting on the infrared spectrogram by using a predetermined Planck blackbody radiation equation, and determining emissivity change characteristics and temperature change characteristics of the surface of the reaction sample; wherein the predetermined Planck blackbody radiation equation is determined by a Planck's blackbody radiation law.

20. The computer-readable storage medium according to claim 18, wherein the performing the data analysis on the infrared images and extracting the kinetic curve from the infrared images comprises:
extracting the kinetic curve of the surface of the reaction sample in the infrared images according to a time sequence; wherein the kinetic curve comprises an adsorption kinetic curve and a desorption kinetic curve; the adsorption kinetic curve is an infrared image intensity curve in an adsorption process of the reaction gas on the surface of the reaction sample; and the desorption kinetic curve is an infrared image intensity curve in a desorption process of the reaction gas from the surface of the reaction sample; and
wherein in the case that the reaction sample is the solid sample, fitting the kinetic curve by using the predetermined adsorption kinetic equation to determine the kinetic data of the surface of the reaction sample comprises:
fitting the kinetic curve by using the predetermined adsorption kinetic equation to determine a kinetic rate constant of the adsorption process and a kinetic rate constant of the desorption process; wherein the predetermined adsorption kinetic equation is determined by a Langmuir adsorption law; and determining an equilibrium constant of gas-solid interface reaction according to the kinetic rate constant of the adsorption process and the kinetic rate constant of the desorption process.
